(19) United States
(12) Patent Application Publication
(10) Pub. No.: US 2002/0048448 A1
(43) Pub. Date: Apr. 25, 2002

(54) Pausing the display of a television program as a signal including the television program is received

(75) Inventor: John J. Daniels, Waterbury, CT (US)

Correspondence Address: WORKMAN NYDEGGER & SEELEY, 1000 EAGLE GATE TOWER, 60 EAST SOUTH TEMPLE, SALT LAKE CITY, UT, 84111, US

(73) Assignee: Microsoft Corporation

(21) Appl. No.: 09/952,582

(22) Filed: Sep. 12, 2001

Related U.S. Application Data
(63) Continuation of application No. 08/306,642, filed on Sep. 15, 1994.
Application No. 08/306,642 is a continuation-in-part of application No. 08/038,240, filed on Mar. 29, 1993, now abandoned.

(51) Int. Cl. H04N 9/79

(52) U.S. Cl. 386/40; 386/124

(57) ABSTRACT

A time shifting event recorder receives a time sequential signal representing an event through an antenna, cable or the like. A portion of the signal is recorded in a first recording medium. A second recording medium is used to record another portion of the signal different from the portion recorded in the first recording medium. At selected intervals, the respective recorded portions of the signal are retrieved and a playback signal is generated therefrom. The recording of the respective portions of the signal in the first and second recording media is controlled by a user so that portions of the event can be recorded while other portions are displayed. Retrieving the selectable intervals of the respective portions of the signal and the generation of the playback signal are also controlled by the user so that the user can view or listen to a time-shifted representation of the event.

### CROSS-REFERENCE TO RELATED APPLICATIONS

This application is a continuation of U.S. patent application Ser. No. 08/306,642, filed Sep. 15, 1994, which is a continuation-in-part of U.S. patent application Ser. No. 08/038,240, filed Mar. 29, 1993, now abandoned. The foregoing patent applications are incorporated herein by reference.

### BACKGROUND OF THE INVENTION

1. The Field of the Invention

The present invention pertains to a time shifting event recorder. More particularly, the present invention pertains to a time shifting event recorder capable of simultaneously recording a portion of an event while playing back a previously recorded interval of the event so as to be effective in time shifting the reproduction of the recorded event. The present invention also pertains to an auto-editing device, and more particularly, to an auto-editing device for use with a video recording camera and a time shifting event recorded.

2. Background and Related Art

The present invention pertains to a time shifting event recorder. More particularly, the present invention pertains to a time shifting event recorder capable of simultaneously recording a portion of an event while playing back a previously recorded interval of the event so as to be effective in time shifting the reproduction of the recorded event. The present invention also pertains to an auto-editing device, and more particularly, to an auto-editing device for use with a video recording camera and a time shifting event recorded.

Ever since events have been transmitted to and received by devices, such as radios and televisions, people have desired to be able to pause the display of the continuous event at selectable periods. Consider a program being watched on a television and a viewer leaves the room or attends to, for example, a phone call. In this case, the display would preferably be interrupted so that the viewer does not miss any of the programs. Upon returning, it is desirable to be able to begin viewing or listening to the transmitted event from the point at which the viewer left the room.

Also, when watching television, very often the viewer would like to return to a previous period in the continuously transmitted event to review that interval again. This is conventionally possible using a recording, such as a video tape of the event. In this case, the user is able to pause the video tape at any desired time. Then, at any future time the viewer can begin playing the tape again and watch the recorded event starting from the point of time on the tape at which its play back was stopped. Or, if an interesting thing occurs during the viewing of the recorded event, the viewer can rewind the video tape and watch the interesting event interval over and over again. After watching this interesting event interval, the viewer can allow the tape to continually play to watch the rest of the event.

However, in the case of a transmitted program, such as a movie received by the viewer's television, there is no way in the conventional art to temporarily pause the viewing of the transmitted program at any desired time and then later return to the transmitted program picking up at that point in time when the pause began.

For example, a viewer watching a show may be interrupted by a phone call. Traditionally, the viewer must either ignore the call and continue watching the program, or take the call and miss that interval of the program which coincides with the duration of the phone call. When the viewer returns from the phone call the program has proceeded to a different point in time and the viewer is not able to watch the interval of the program which coincides with the time of the phone call.

Also, there may be two programs being received by the viewer's television of interest to the viewer. In this case, a viewer with a VCR tape recorder may tape one of the shows while viewing the other. Then, the viewer can watch one of the shows as it is being transmitted and at a later time watch the taped show. However, there is no conventional way for such a viewer to temporarily pause from the viewing of one show and switching to the other show to watch an interesting portion thereof, then switch back to the first show and begin viewing from the point at the beginning of the pause. Rather, the viewer returns to the first show at a point in time of the first show further along than the point in time of the beginning of the pause. Therefore, the viewer misses that portion of the first show which elapsed during the switch to the other program.

In addition, the use of a video camera for recording events has become widespread. Particularly, a video camera is pervasively used in the news-gathering field to capture images of real time events for later display and broadcast. Also, due to the advent of the home video player and video camcorder, the general public now records personal events using hand-held video cameras. A video camera uses a magnetic tape to store the images of an event for later display.

However, typically when filming an event the video camera is set to record during durations of time that not only capture the desired portion of an event, or interesting occurrence, but which also record periods of superfluous and uninteresting footage. In order to capture the desired event, or interesting occurrence, it is necessary for the camera to be recording and one can not necessarily predict when an interesting occurrence that should be recorded will happen. Therefore, since an event or interesting occurrence will often happen at times which are entirely unpredictable, to capture the desired unpredictable event the video camera must continuously record the superfluous footage, or risk the chance of not capturing the desired event.

In order to concentrate and make an interesting final product, particularly in the case of a news event due to the limitation of broadcast time, extensive editing is usually required. Typically, this editing requires post recording viewing of the entire video tape during which time interesting moments captured on the tape are transferred to another video tape, while leaving out the uninteresting or undesired recorded portions. Also, in the case of a personal-use video recorder, the user is often inexperienced at video taping and will either video tape a copious amount of uninteresting footage, or, for fear of recording too much boring footage that must later be laboriously edited, miss the capturing of an unpredictable, but interesting event. Again, even for the work of an experience videographer, the time consuming and tedious post recording editing process must be performed in order to obtain an interesting and concise end product.

There are other commercial uses for video recorders. For example, is common practice for the organizer of a scuba diving outing to bring along an underwater video camera to videotape clients so that each client may take home a copy of their underwater adventure. However, this often results in much footage that is not very interesting to a particular client, because the subject matter of much of the video tape pertains to strangers of which the particular client has little or no interest in. Therefore, in order to produce a more interesting tape, the video tape should be edited for each individual client to concentrate on those portions that are interesting to each particular individual.

Also, there are times when a more concise and a more detailed edited version of an event is desired. For example, when videotaping a wedding ceremony, it is common to limit the captured footage to only specific portions; such as the entry of the bride, taking of wedding vows, etc. losing forever the rest of the long ceremony. However, it would be advantageous to record the entire ceremony, then edit a detailed version containing entry of the entire wedding party, taking of the vows, etc. (while deleting the more banal periods of the ceremony). Further, an even more concise version could be edited, containing only the entry of the bride, taking of the vows etc., or different versions one concentrating on the groom's family and the other concentrating on the bride's family. However, to obtain multiple editions of the event would conventionally require so much editing, that it is more common simply to record either snippets of the important aspects of the wedding, leaving the rest forever lost from review, or to record the entire ceremony making the videotape boring.

Also, different edited editions of the event may be desired. For example, multiple edited edition of a group activity may be advantageous (i.e., a coach can video tape an entire game played by an opponent, and separately selectively edit the play of key players). Also, very interesting portions of a recorded event may be recorded twice in the edited edition so that during play of the video tape the very interesting portion is viewed two or more times.

Furthermore, as video recorders become more popular, it is becoming more common place for two or more people in a particular group to have personal video recorders taping an event that the group is participating in. It is very difficult, if not impossible, to concentrate the footage recorded by two or more videographers through post recording editing of two or more video tapes to obtain a final product having a correct time sequence of the event taken from two or more perspectives. Such a final product should switch between the footage taken by each videographer during the recorded event, which would require extremely complicated post recording editing. Rather, it is common place merely to swap copies of videotapes so that each videographer ends up with recordings of the event taken from the perspective of the other, with no switching or time-sequentially mixing of the perspectives of more than one videographer on a single final product video tape. Thus, when two or more people are videotaping an event, it is nearly impossible to obtain a single final tape which time sequentially splices together the perspective of the different videographers recording the action. However, such a final tape product would be most desirable and most interesting to view.

In addition, in order to reduce the quantity of footage taken so that post recording editing can be reduced or eliminated, it is very common (particularly for non-professional videographers) to only record during instances when a planned event is taken place. However, since it is usually impossible to predict when an interesting occurrence will happen, this technique is inadequate and often results in the failure to record all or at least the beginning of the interesting event. This happens even though a video recorder is at hand, simply because the videographer does not want to over-record and produce a boring tape containing long periods of uneventful occurrences that must later be laboriously edited, requiring the viewing during the editing process of the entire tape, and the rewinding and re-recording to another tape when an interesting event is observed.

By way of example, when videotaping a person catching a fish there is usually a long period when the line is in the water, but the fish has not yet struck. However, since it is impossible to predict precisely when a fish will strike, if it is desired to catch the initial excitement of the hooking of the fish, the video recorder must be recording constantly. Then, to delete the boring waiting period before the fish strike, extensive post recording editing efforts are required, including viewing the tape until the desired event beginning (i.e., the initial bending of the fishing pole indicating a strike), then rewinding past the beginning and then recording the desired event onto another video tape. Alternatively, if the video recorder is only switched on after the fish strike, than only the fight of the fight and landing of the fish will be recorded, while the exciting initial strike will not be captured on the video tape and is lost forever. Also, during the fight of the fish, particularly when fishing for big game fish, there are extended periods when the action is repetitive and boring to watch later on videotape. However, when a big fish makes an exciting leap from the water (which may occur at unpredictable times), this event should be captured because it is a very interesting portion of the fishing experience. To catch the jumps and other exciting portions of taking the fish, the video camera must continuously record the event (including the superfluous boring portions). At a later time, and after much labor, the video tape can be edited to include only the most exciting portions. There are no devices that automatically obtain an edited version of a recorded event, without a laborious post-recording editing process.

Therefore, there is a need for a time shifting event recorder capable of allowing a viewer to temporarily pause and then return to a broadcast program without missing any of the program. There is also a need for a time shifting event recorder that can be used as a playback device to provide an automatic editing device for automatically editing an event recorded by a videocamera.

### BRIEF SUMMARY OF THE INVENTION

The present invention is intended to overcome the drawbacks of the conventional art. It is an object of the present invention to provide a time shifting event recorder capable of recording portions of a time sequential signal representing an event so that a representation of the event can be produced in a time shifted manner. The present invention to overcomes the many drawbacks of conventional post recording editing of video taped events, such as those delineated above. It is another object of the present invention to provide an automatic editing device, for use with audio and/or video equipment, which is capable for “live” editing of an event being recorded. Such an automatic editing device utilizes the playback capabilities of the inventive time shifting event recorder to generate video signals of videotapes containing a recorded event that is automatically edited.

In accordance with the present invention, a time shifting event recorder is provided including receiving means for receiving a time sequential signal representing an event. First recording means records in a first recording medium at least one selected portion of the time sequential signal and second recording means records in a second recording medium at least one other selected portion of the time sequential signal different from the at least one selected portion recorded by the first recording means. Retrieving means retrieves at selectable intervals the respective selected portions of the time sequential signal recorded in the first and second recording mediums and generates a playback signal dependent thereon. Controlling means controls the first and second recording means to record the respective selected portions of the time sequential signal. The controlling means also controls the retrieving means to retrieve at the selectable intervals the respected selected portions of the time sequential signal and generate the playback signal, so that a representation of the event can be produced in a time shifted manner.

The time sequential signal can be either a video, audio, or other information carrying signal. The recording mediums can be a magnetic tape, a magnetic disk, an electronic memory circuit, an optically recordable disk, or any other suitable recording medium. In accordance with one embodiment of the present invention, each recording medium is part of a same recording medium, such as a same recordable disk. Remote control inputting means may be provided for inputting user selectable control signals to the controlling means so as to control the production of the representation of the event in a user definable time shifted manner. The time sequential signal can be stored as digital data, analog data, and the like.

In accordance with another embodiment of the present invention, third recording means are provided for recording in a third recording medium gap portions of the time sequential signal different from the portions recorded by the first and second recording mediums. The gap portions are recorded at a time when either of the first or second recording means is not able to record the time sequential signal (such as during a rewind or playback period). The retrieving means is capable of retrieving at a gap interval each gap portion of the time sequential signal recorded in the third recording medium. The controlling means controls the third recording means to record each gap portion of the time sequential signal. The controlling means also controls the retrieving means to generate the playback signal so that a representation of the event can be produced in a time shifted manner, without a break caused by a time when either of the first or second recording means is not able to record the time sequential signal.

In accordance with still another embodiment of the present invention, one of the recording means consists of an already existing recording apparatus such as a VCR videotape recorder. In this embodiment, the controlling means is adapted to control both a first recording means and the recording apparatus so that a representation of the event can be produced in a time shifted manner. The controlling means may control the recording apparatus (VCR) via remote control signals by accessing the VCRs remote control capabilities.

In yet another embodiment of the present invention, supplying means are provided for supplying a playback signal of a previously recorded portion of the time sequential signal and a current portion of the time sequential signal to a display device simultaneously so that a time shifted representation of the event can be displayed simultaneously with a current representation of the event on the display device. In this embodiment, the viewer is thus able to return to a portion of the event being viewed and watch that portion again while simultaneously viewing the event in real time. In fact, the viewer may view other portions of the event, recorded on the second, third, etc. recording mediums, simultaneously with the portion recorded on the first recording medium and/or the current reproduction of the event.

It is another object of the present invention to provide an automatic editing device which is also capable of providing two or more “live” editing sequences. It is still another object of the present invention to provide such an auto-editing device capable of time-sequentially “live” editing of a recorded event, the event being recorded simultaneously by two or more recording devices such as tape recorders, video recorders or the like.

In accordance with this aspect of the invention, an event-recording device records an event on a recording medium. At least one edit-record interval is selected during the recording of the event corresponding to a respective selected portion of the recorded event. A start-record signal is generated dependent on each selected edit-record interval. Each start-signal is recorded on the recording medium along with the recorded event. During a subsequent edit-recording operation each start-record signal is detected from the recording medium, and a playback device and an edited-recording device are controlled during the edit-recording operation so that a play-back operation to play-back the event from the recording medium is performed by the playback device and a record operation to record an edited version of the event is performed by the edited-recording means depending on each detected start-record signal to automatically edit and record a copy of the recorded event having each selected edit-record interval, without including the unselected portions of the recorded event. The playback capabilities of the inventive time shifting event recorder can be used to perform the playback operation, thus enhancing the capabilities and usefulness of the inventive time shifting event recorder. To reduce the automatic editing time, the playback device (time shifting event recorder) can be controlled to fast forward the recording medium through periods of the recorded event that are not a selected edit-record interval. A beginning time of the edit-record interval occurring at a time prior to a time that the edit-record interval can be selected, and the start-record signal generated to include a beginning time data. The playback device can be controlled to rewind the recording medium to the beginning time of the edit-record interval dependent on the start-record signal and the beginning time data. An edit-edition can be selected for each edit record interval; and the start-record signal generated to include an edit-edition data. An edition copy of the recorded event having each selected edit/record interval being the same edit-version can thus be automatically edited. In accordance with another aspect of the invention, an auto-editing device is provided for at least two recording apparatus capable of simultaneously recording an event on a respective recording medium. A user can select a perspective of the event being recorded taken by a first recording apparatus (the user's camera) and a second perspective of the event being recorded taken by a second recording apparatus (a companion's camera). A corresponding start-record signal is generated dependent on the selected perspective. Each start-signal is recorded on the recording medium during the recording of the event. During a subsequent edit-recording operation, the start-record signal from the recording medium is detected. A edit recording device is controlled so that a single copy of the recorded event is produced having both the first perspective of the event being recorded taken by the first recording apparatus and the second perspective of the event being recorded taken by the second recording apparatus. A playback device, such as the time shifting event recorder, is used to playback and to generate video signals from both the first recording medium and the second recording medium simultaneously.

### BRIEF DESCRIPTION OF THE DRAWINGS

FIG. 1 is a block diagram showing an embodiment of the time shifting event recorder in accordance with the present invention;

FIG. 2(a) is an illustration showing the timing of the inventive time shifting event recorder when the viewer takes breaks from viewing a program;

FIG. 2(b) is an illustration showing the timing of the inventive time shifting event recorder when the viewer views portions of a program over again;

FIG. 3(a) is a block diagram showing a second embodiment of the inventive time shifting event recorder;

FIG. 3(b) is a block diagram showing a third embodiment of the inventive time shifting event recorder;

FIG. 4(a) is a drawing showing a configuration of the inventive time shifting event recorder;

FIG. 4(b) is a drawing showing another configuration of the inventive time shifting event recorder;

FIG. 4(c) is a drawing showing still another configuration of the inventive time shifting event recorder;

FIG. 5(a) is a drawing showing a configuration of reading/writing heads of recording means associated with a same recordable disk recording medium;

FIG. 5(b) is another configuration of reading/writing heads of recording means associated with a same recordable disk recording medium;

FIG. 6 is a block diagram of another embodiment of the inventive time shifting event recorder;

FIG. 7(a) is a perspective view of an embodiment in accordance with another aspect of the present invention for playing synchronized recordings and for producing an automatically edited version of a recorded event;

FIG. 7(b) is a perspective view of the embodiment of the present invention shown in FIG. 7(a), showing user definable perspectives of the synchronized recordings played simultaneously on a monitor;

FIG. 7(c) is a block diagram of components of the embodiment of the invention shown in FIG. 7(a);

FIG. 8(a) is a block diagram of an inventive automatic edit event recording system;

FIG. 8(b) is a block diagram of an inventive automatic edit playback and edited-recording system;

FIG. 8(c) is a block diagram of an inventive automatic edit event recording system having a manual control button for selecting a beginning time of an edit-record interval;

FIG. 8(d) is a graphic illustration showing an example of a time relationship of an inventive automatic editing operation with manual beginning time selection;

FIG. 8(e) is a flow diagram of an automatic edit event recording operation in accordance with the time relationships shown in FIG. 8(d);

FIG. 8(f) is a flow diagram of an automatic edit playback and edited-recording operation in accordance with the time relationships shown in FIG. 8(d);

FIG. 9(a) is an illustration showing the timing of an example of the operation of the automatic edit event recording operation;

FIG. 9(b) is an illustration showing the timing of an example of the automatic edit playback and edited-recording operation;

FIG. 10(a) is a block diagram of an inventive automatic edit event recording system having manual control buttons for selecting automatically edited versions of a recorded event;

FIG. 10(b) is a graphic illustration showing an example of a time relationship of an inventive automatic editing system with manual edition selection;

FIG. 10(c) is a flow diagram of an automatic edit event recording operation in accordance with the time relationships shown in FIG. 10(b);

FIG. 10(d) is a flow diagram of an automatic edit playback and edited-recording operation in accordance with the time relationships shown in FIG. 10(b);

FIG. 11(a) is an illustration showing the timing of an example of the operation of the automatic edit event recording operation with edition selection;

FIG. 11(b) is an illustration showing the timing of an example of the automatic edit playback and edited-recording operation with edition selection;

FIG. 12(a) is a block diagram of an inventive automatic edit event recording system having a synchronizing system for synchronizing two or more recorded perspectives of a recorded event;

FIG. 12(b) is a block diagram of an inventive automatic edit playback and editing recording system having a synchronizing system for synchronizing two or more recorded perspectives;

FIG. 12(c) is an isolated block diagram of a synchronizing system;

FIG. 12(d) is an isolated block diagram of a synchronization signal generator;

FIG. 12(e) is an isolated block diagram of an edit signal generator 68;

FIG. 12(f) is an isolated block diagram of an edit signal detector;

FIG. 13(a) is a block diagram of an inventive automatic edit event recording system having manual control buttons for selecting perspectives of a recorded event;

FIG. 13(b) is a graphic illustration showing an example of a time relationship of an inventive automatic editing system with perspective selection;

FIG. 13(c) is a flow diagram of an automatic edit event recording operation in accordance with the time relationships shown in FIG. 10(b);

FIG. 13(d) is a flow diagram of an automatic edit playback and edited-recording operation in accordance with the time relationships shown in FIG. 13(b);

FIG. 14 is an illustration showing the timing of an example of the operation of the automatic edit event recording operation with perspective selection;

FIG. 15(a) is an illustration of an event being recorded;

FIG. 15(b) shows two recorded perspectives of the event being recorded shown in FIG. 15(a);

FIG. 15(c) shows two recorded perspective of the event being recorded in FIG. 15(a);

FIG. 16(a) shows a viewfinder image of a first camera with video link views from a second and a third camera showing three perspectives of the event being recorded shown in FIG. 15(a);

FIG. 16(b) shows the viewfinder image of the second camera; and

FIG. 16(c) shows the viewfinder image of the third camera.

### DETAILED DESCRIPTION OF THE PREFERRED EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended, there being contemplated such alterations and modifications of the illustrated device, and such further applications of the principles of the invention as disclosed herein, as would normally occur to one skilled in the art to which the invention pertains.

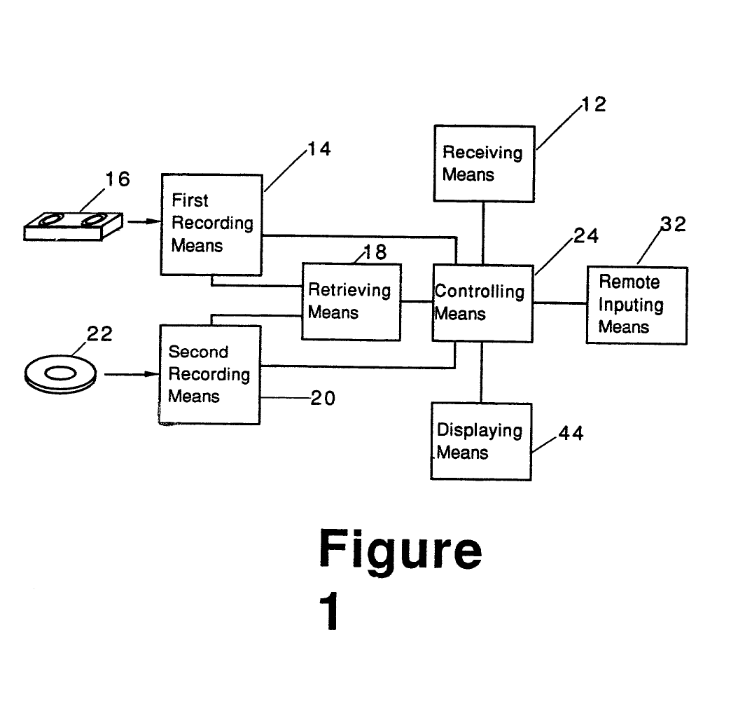

Referring to FIG. 1, an embodiment of the inventive time shifting event recorder will be described. Receiving means 12 receives a time sequential signal representing an event. The time sequential signal may be, for example, a program broadcast via radio waves for display on, for example, a television or a radio. The time sequential signal may also be transmitted through a transmission medium, other than the air, such as a coaxial cable used by the cable television industry. Conventionally, this time sequential signal is converted into visual video signals and/or audible audio signals so that a continuous representation of the event can be viewed and/or listened to by an observer. However, if the observer is distracted from observation of the time sequential representation of the event, there is no conventional way to time shift the observable representation of the event, other than by the conventional method of recording the entire rest of the time sequential signal, waiting until the event (such as a television program) is over, and then rewinding and replaying the recorded time sequential signal.

To overcome this drawback, in accordance with the present invention, first recording means 14 records in a first recording medium 16 at least one selected portion of the time sequential signal. In other words, if the viewer of a television program were to leave the room, the first recording means 14 is activated to record that selected portion of the time sequential signal received during the viewer's absence. Upon returning, the viewer activates the retrieving means 18 to retrieve at the selectable interval (the viewer's return), the recorded selected portion of the time sequential signal recorded in the first recording medium 16 during the viewer's absence. The retrieving means 18 produces a playback signal from this recorded time sequential signal portion so that the viewer can view the television program where he or she left off. While the viewer is viewing the time shifted portion of the television program, a second recording means 20 records in a second recording medium 22 another selected portion of the time sequential signal. In other words, since the television program continues on time sequentially, while the viewer is viewing the first recorded portion recorded in the first recording medium 16, the second recording means 20 continues recording the time sequential signal at the point at which the recording by the first recording means 14 is stopped so that the signal can be played back.

After the time sequential signal recorded by the first recording means 14 has been played back (so that the viewer is able to view that portion of the television program that was aired in his absence), the retrieving means 18 retrieves the portion of the time sequential signal recorded by the second recording means 20 so that it may be played back. Thus, the continuous time sequential signal representing the event (the television program) is time shifted and the viewer views the program continuously upon returning, starting from the point in time at which the viewer first stopped viewing the program. Controlling means 24 controls the first and second recording means 20 to record the respective selected portions of the time sequential signal. The controlling means 24 also controls the retrieving means 18 to retrieve at the selectable intervals the respective selected portions of the time sequential signal, so that the playback signal can be generated and a representation of the event can be produced in a time shifted manner.

The time sequential signal can be a video signal or an audio signal. The recording mediums can be a magnetic tape, a magnetic disk, an electronic memory circuit (such as an EPROM, or other electronic storage device) an optically recordable disk recording medium, or any recording medium now known or later developed.

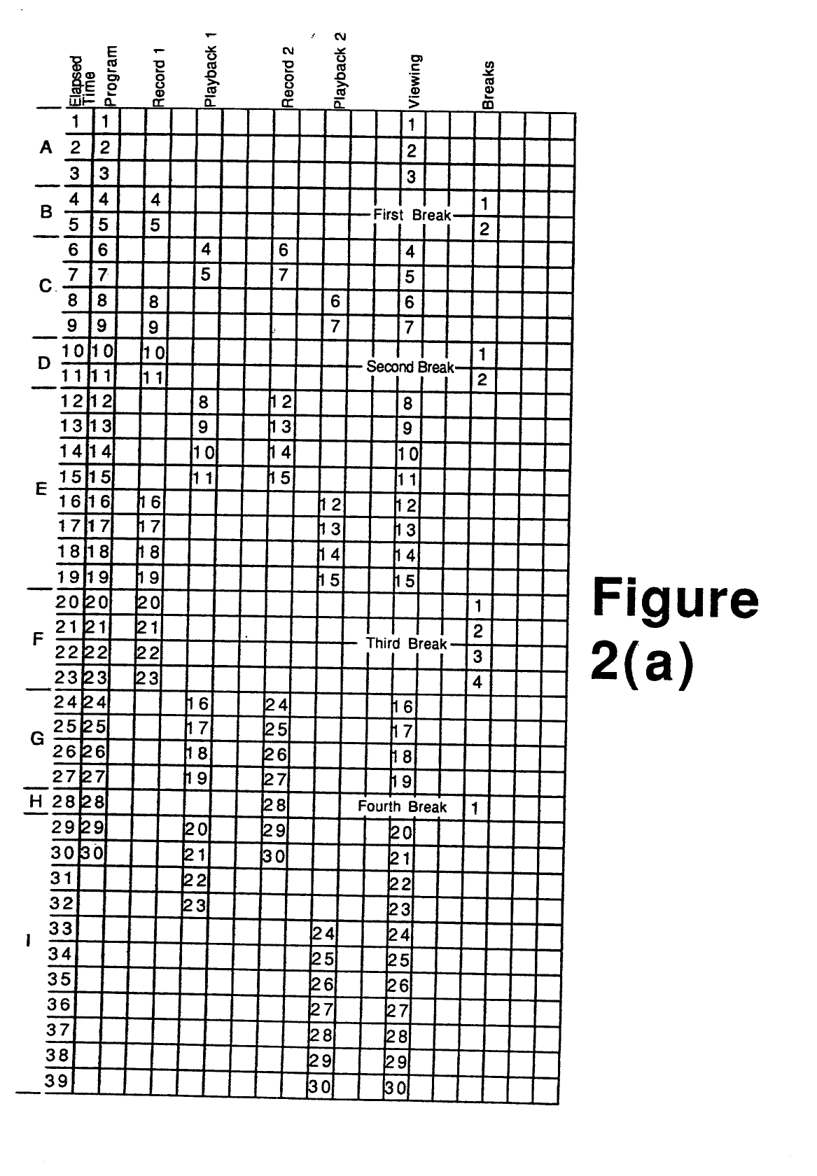

Referring now to FIG. 2(a), the timing of the inventive time shifting event recorder will be described. In the example shown, the total time of the event (program) is 30 minutes. However, the timing of the use of the inventive time shifting event recorder is illustrated by way of example only. During interval (A), the Elapsed Time runs from the minutes 1 to 3. The program runs from minutes 1 to 3 and is viewed in real time, as shown by the viewing of minutes 1 to 3 coinciding with the Elapsed Time of minutes 1 to 3. In interval (B), the viewer takes a First Break having a duration of 2 minutes. During interval (B), the Elapsed Time continues on to minutes 4 to 5 and the program also continues to minutes 4 to 5. At the start of the First Break (the end of minute 3 and the beginning of minute 4) the first recording means 14 begins recording the program during the break and minutes 4 and 5 of the program are recorded. When the viewer returns at the start of interval (C), the minutes 4 to 5 of the program recorded by the first recording means 14 are played back and viewed. While the minutes 4 to 5 are being played back, the Elapsed Time continues to minutes 6 to 7 and the program continues to minutes 6 to 7. Minutes 6 to 7 of the program are recorded at this time by the second recording means 20 During minutes 8 to 9 of the Elapsed Time, the first recording means 14 records minutes 8 to 9 of the program while the retrieving means 18 retrieves the minutes 6 to 7 of the program recorded on the second recording means 20 so that this duration of the program can be viewed.

Referring now to interval (D), the Elapsed Time continues on to minutes 10 to 11 while the program continues on to its 10th and 11th minutes. These 10th and 11th minutes of the program are recorded by the first recording means 14 continuously following minutes 8 to 9 being recorded. However, the viewer takes a Second Break having a duration of 2 minutes. At the beginning of interval (E) the Elapsed Time continues on starting from minute 12 and the program continues on from minute 12. The viewer returns from the break and the retrieving means 18 retrieves minutes 8 to 11 from the first recording means 14 for viewing while the second recording means 20 records minutes 12 to 15. After the 15th minute of the Elapsed Time has elapsed, the retrieving means 18 switches to retrieve the recorded minutes 12 to 15 of the program from the second recording means 20 for viewing, while minutes 16 to 19 of the program are simultaneously recorded on the first recording means 14.

Referring now to interval (F), during minutes 20 to 23 of the Elapsed Time (coinciding with minutes 20 to 23 of the continuously running program) the viewer takes a Third Break. This break has a duration of 4 minutes. During these 4 minutes the first recording means 14 continues recording the program so that minutes 20 to 23 of the program are stored. Upon return to viewing by the viewer, as shown in interval (G), minutes 16 to 19 recorded on the first recording means 14 are play back for viewing during minutes 24 to 27 Elapsed Time. Simultaneously, the second recording means 20 records minutes 24 to 27 of the program.

In interval (H), the viewer takes a Fourth Break having a duration of one minute. The second recording means 20 continues recoding the 28^{th} minute of the program. Upon viewer's return, minutes 20 to 23 of the program are retrieved from the first recording mean 14 during Elapsed Time of minutes 29 to 32 (the beginning interval (I)). Since the program has a duration of 30 minutes, during minutes 29 to 30 of the program, the second recording means 20 continues recording so that these two minutes are stored. After the 32 minute of Elapsed Time the viewer will have finished viewing the 23^{rd} minute of the program stored on the first storing means. The retrieving means 18 then switches to retrieve minutes 24 to 30 of the program recorded on the second recording means 20 which is viewed by the viewer during the minutes 33 to 39 of the Elapsed Time.

In summary, the viewer is thus able to take four arbitrary breaks while viewing continuously aired program. These four breaks total nine minutes in duration. By selectively recording the retrieving the program minutes stored on the first and second recording means 20, the viewer is able to time shift the viewing of the continuously aired program and can view the program after returning from a break starting at a point in the program at which the break started. Since the program is 30 minutes in duration and the viewer took nine minutes total in breaks, the total Elapsed Time required for viewing the entire program is 39 minutes. Thus, in accordance with the present invention, a time shifting event recorder is provided which allows a user to arbitrarily take breaks in viewing a program and then return to viewing the program without missing any of it.

Referring now to FIG. 2(b), the timing of the inventive time shifting event recorder used when the viewer views portions of a program over again will be described. As in FIG. 2(a), the total time of the event (program) is 30 minutes. During interval (A), the E lapsed Time continues from minutes 1 to 5, the program continues from minutes 1 to 5 and is viewed in real time. The first recording means 14 records minutes 1 to 5 so that the viewer can arbitrarily decide to view again any portion of the program.

At interval (B), the Elapsed Time continues through minutes 6 to 8 and the Program continues through minutes 6 to 8. However, the viewer decides to view minutes 3 to 5 again. Thus, minutes 3 to 5 are played back from the first recording means 14 while minutes 6 to 8 of the Program are recorded by the second recording means 20.

At interval (C), the Elapsed Time and the Program continue through minutes 9 to 1. Minutes 6 to 8 are played back from the second recording means 20 so that these minutes of the Program can be viewed in a time shifted manner subsequent to viewing minute 5 again. During this time, minutes 9 to 11 of the Program are recorded by the first recording means 14.

At interval (D), the viewer decides to view again minutes 7 to 8. However, after viewing minutes 7 to 8 for a second time, the viewer decides to view minutes 7 to 8 for a third time. Thus, during interval (D), the Elapsed Time and Program continue on through minutes 12 to 15. The first recording means 14 continues recording the Program through minutes 12 to 15. During minutes 12 to 13 of the Elapsed Time, minutes 7 to 8 of the Program are played back and viewed again. Then, during minutes 14 to 15 of the Elapsed Time, minutes 7 to 8 of the Program are played back a second time so that the viewer views this portion of the Program a total of three times.

At interval (E), the Elapsed Time continues on through minutes 16 to 31, while the program continues on through minutes 16 to 30, ending at minute 30. From minutes 16 to 22, minutes 9 to 15 of the Program are played back from the first recording means 14 and viewed, while minutes 16 to 22 of the program are recorded by the second recording means 20. Then, at minutes 23 to 29 of the Elapsed Time, the Program continues for minutes 23 to 29 and is recorded by the first recording means 14. At this time, minutes 16 to 22 are played back from the second recording means 20 and viewed. The 30th minute of the Program is recorded in the second recording means 20 during the 30th minute of the Elapsed Time and the final minute of the Program. During minutes 30 to 31, minutes 23 to 24 of the Program are played back from the first recording means 14 and viewed.

At interval (F), during minute 32 of the Elapsed Time, the viewer decides to view again minute 24 of the Program which is played back again from the first recording means 14.

At interval ((3), the Elapsed Time continues through minutes 33 to 35 while minutes 25 to 27 recorded by the first recording means 14 are played back and viewed.

At interval (H), during minute 36 of the Elapsed Time, the viewer decides to view minute 27 of the Program, which is played back again from the first recording means 14.

At interval (I), the Elapsed Time continues through minutes 37 to 39. During minutes 36 to 38 of the Elapsed Time, minutes 28 to 29 of the Program are played back from the first recording means 14 and viewed. Finally, at the 39A:minute of the Elapsed Time, the 30th minute of the Program recorded in the second recording means 20 is played back and viewed.

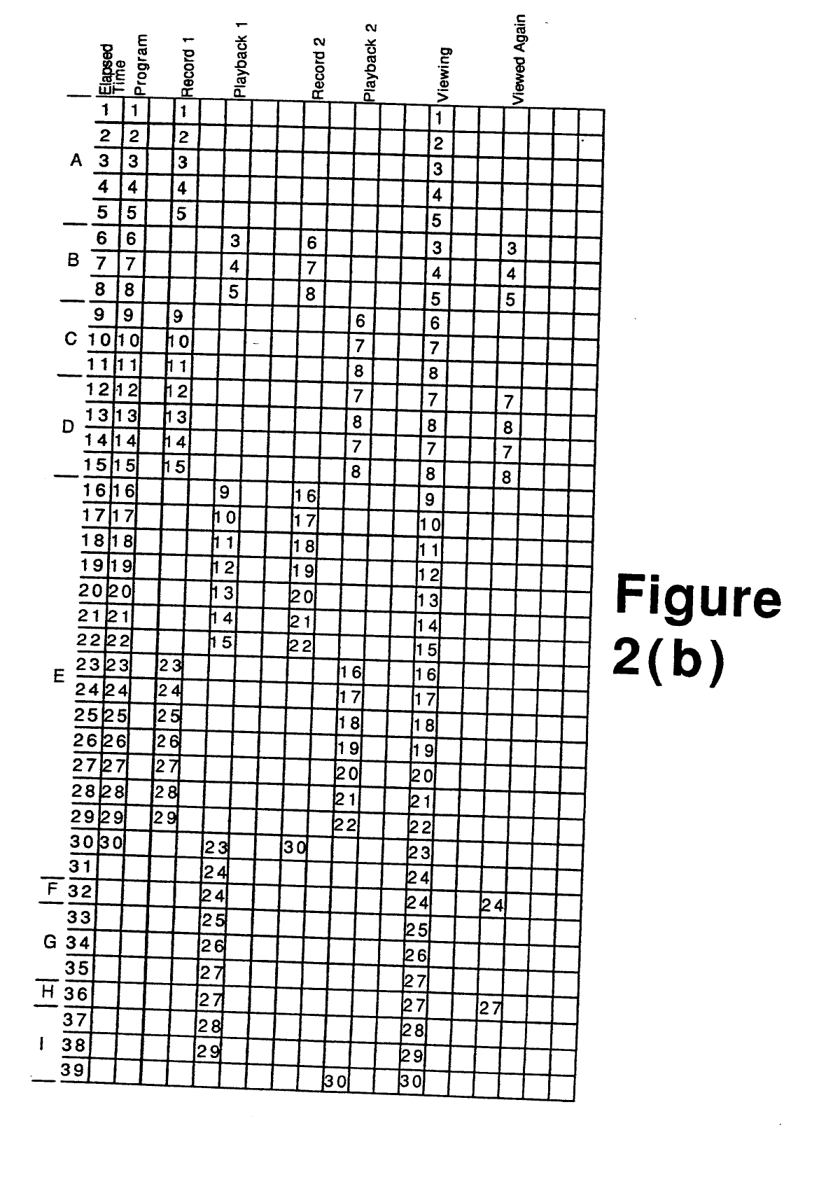

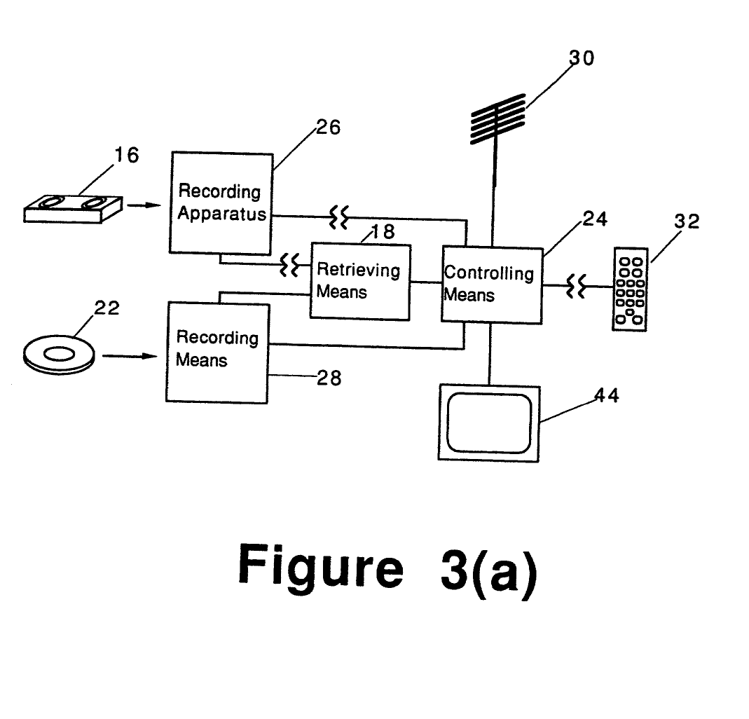

Referring to FIG. 3(a), a block diagram of an embodiment of the inventive time shifting event recorder is shown. The inventive time shifting event recorder is used with a recording apparatus 26 capable of recording in a recordable medium at least one selected portion of a time sequential signal. In other words, the commonly used VCR is such a recoding apparatus 26 which records on magnetic tape a time sequential signal, such as a television program. In accordance with the present invention, receiving means 12 (shown in FIG. 1) receives a time sequential signal representing an event, such as the television program. Recording means 28 records in a recording medium at least one other selected portion of the time sequential signal different from each selected portion recorded by the recording apparatus 26. In other words, the VCR may be used to record a selected portion of the television program while the recording means 28 records other selected portions of the television program so that viewing of the television program can be time shifted in the manner shown by example in FIGS. 2(a) and 2(b).

Retrieving means 18 retrieves at selectable intervals the respective selected portions of the time sequential signal that are recorded in the recordable medium of the recording apparatus 26 (VCR) and the recording medium of the recording means 28. The retrieving means 18 generates a playback signal dependent on these retrieved portions of the time sequential signal so that the television program can be viewed in the time shifted manner as described with reference to FIGS. 2(a) and 2(b). Controlling means 24 controls the recording apparatus 26 and the recording means 28 to record the respective selected portions of the time sequential signal. The controlling means 24 also controls the retrieving means 18 to retrieve at the selectable intervals the respected selected portions of the time sequential signal and generate the playback signal so that a representation of the event can be produced in a time shifted manner.

The time sequential signal can be either a video signal or an audio signal (or other information carrying signal) and may be received via a cable hook up or an antenna 30 which receives broadcasted radio signals. A remote control 32 can be used to input user selectable control signals to the controlling means 24 50 as to control production of the representation of the event in a user definable time shifted manner (as shown by example in FIGS. 2(a) and 2(b)).

The respective portions of the time sequential signal may be retrieved and/or stored as analog or digital data. For example, a newly developed integrated circuit which is capable of storing vast quantities of digital data may be used as the recording means which allows nearly instantaneous retrieval of the time sequential signal recorded therein. The use of such a memory circuit will reduce the complexity of the inventive time shifting event recorder to thereby reduce the cost to produce and/or the size of the device.

Referring now to FIG. 3(b), in accordance with the present invention a third recording means 34 may be provided for recording in a third recording medium 36 at least one gap portion of the time sequential signal different from the portions recorded by the first and second recording means 20. Each gap portion is recorded at a time when either of the first and second recording means 20 is not able to record the time sequential signal. In other words, if for example, one of the recording mediums is a magnetic tape which is being rewound while the other recording medium is playing back a portion of the recorded time sequential signal, the third recording means 34 will be used to record the event (for example the television program) so that there is a continuous recordability of the television program with no lapse in continuity.

In this embodiment, the retrieving means 18 includes means for retrieving at a gap interval each gap portion of the time sequential signal recorded in the third recording medium 36 and generating a playback signal dependent thereon. The controlling means 24 includes means for controlling the third recording means 34 to record each gap portion of the time sequential signal in the third recording means 34. The controlling means 24 further comprises means for controlling the retrieving means 18 to retrieve each gap portion of the time sequential signal, and to generate the playback signal so that a representation of the event can be reproduced in a time shifted manner without a break in continuity caused by a time when either of the first and second recording means 20 is not able to record the time sequential signal.

With regard to at least some of the recording mediums, such as the disk type (magnetic or optic) and the memory circuit, it is possible that only one such recording medium is necessary to construct the invention. In this case, different portions of the recording medium are used and controlled to simultaneously record at one portion while playing back information recorded at another. This will further improve the device by reducing complexity and costs to make.

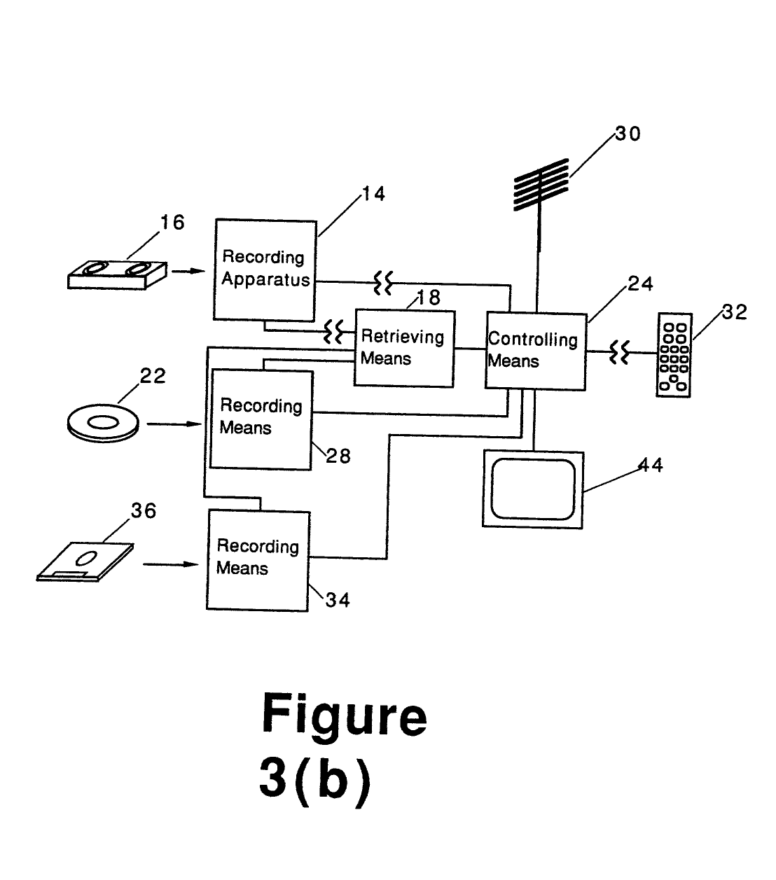

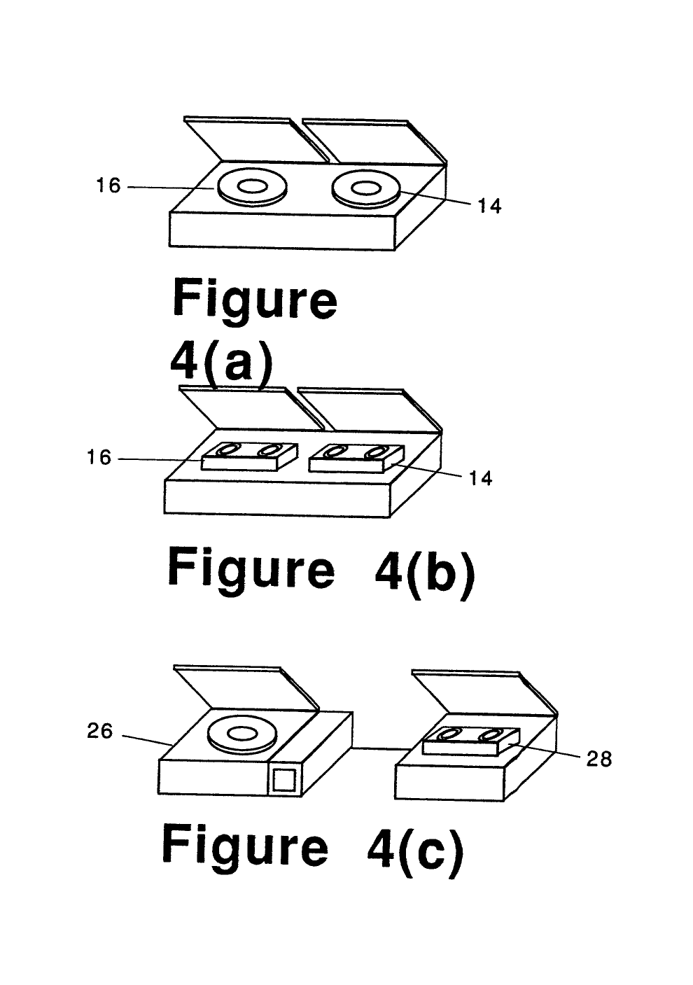

FIGS. 4(a) through 4(c) represent various configurations of the invention which utilize two separate recording means. For example, in FIG. 4(a) the same type of recording means is used, namely an optical disk. Thus, the first and second recording means 16 and 20 are provided in a single unit and the device may further be utilized to make a copy of an original disk onto the other disk. Similarly, FIG. 4(b) shows the device configured wherein the two recording means both record the time sequential signal on a video tape recording medium. It is noted that this video tape may be a continuous loop video tape so that retrieval of the portions of the time sequential signal can be retrieved by rewinding or fast forwarding the tape in the appropriate direction which most efficiently positions the tape at the beginning of the selected portion. FIG. 4(c) shows a configuration in which the inventive time shifting event recorder is used in combination with an already existing recording apparatus 26 such as a VCR, capable of recording in a recordable medium, such as a magnetic tape, the time sequential signal. In this case, the controlling means 24 may include means for controlling the recording apparatus 26 (VCR) via remote control signals. In other words, since most VCRs are capable of being controlled by remote control signals, a mechanical link between the inventive time shifting event recorder and the VCR may be obviated by controlling the VCR via its remote control capabilities.

FIGS. 5(a) and 5(b) show the configuration of the first and second recording medium 16 and 22 of the inventive time shifting event recorder shown, for example, in FIG. 1. In this case, the first recording medium 16 comprises at least one portion of a recordable disk and the second recording medium 22 comprises at least one other portion of the same recordable disk. Read/write heads of the respective recording means are able to retrieve and write information on different portions of the same recordable disk simultaneously. Thus, a single recordable disk is used as the recording medium for both the first and second recording means 20. As shown in FIG. 5(a), the recordable disk is recorded on one side thereof by both read/write heads 38 of the respective recording means. FIG. 5(b), on the other hand, shows a configuration in which the disk recording medium is recorded on both sides thereof In this case, the read/write head 38 of one of the recording means records on one side while the read/write head 38 of another of the recording means records on the other. It is noted that if a third or more recording means is utilized, then another read/write head 38 may be used to record and playback information from different portions of the disk recording means. In the case of the memory circuit, the idea is the same. Namely, each recording means records the respective portions of the time sequential signal at, for example, different address locations of the memory circuit and these locations are addressed to retrieve the stored information.

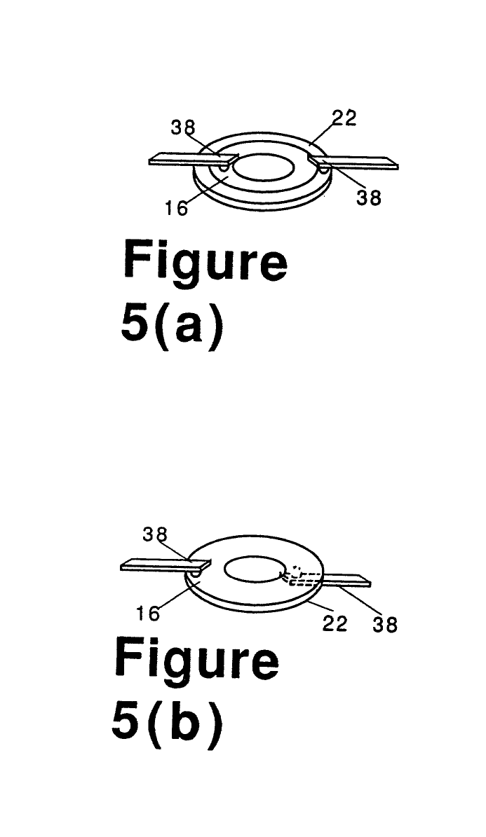

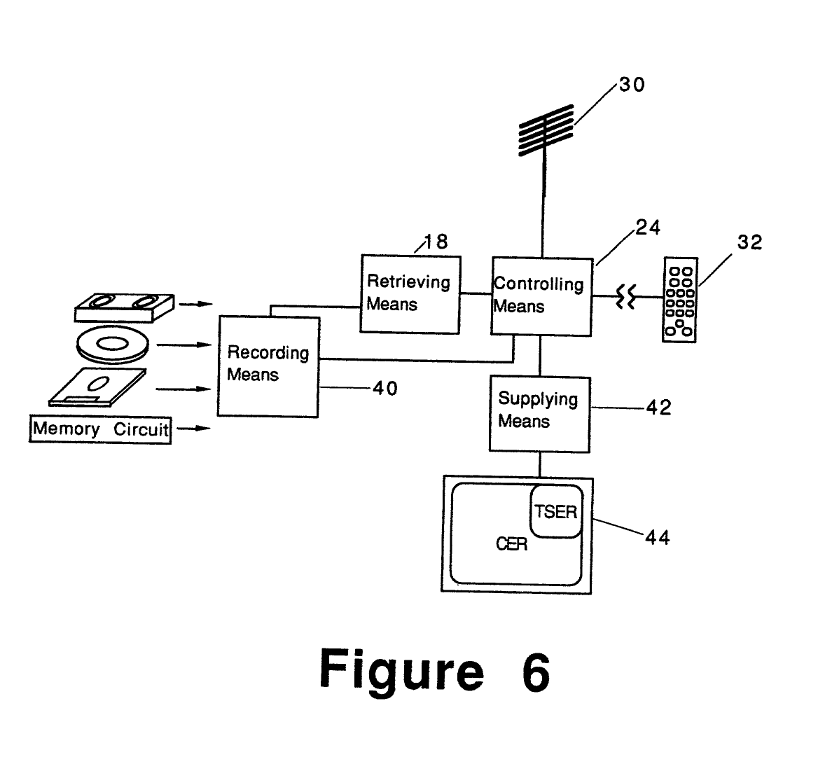

Referring now to FIG. 6, an embodiment of the inventive time shifting event recorder for displaying a time shifted representation of an event on a display device is shown. Receiving means 12, such as an aerial antenna 30 for receiving a broadcast signal or a cable coaxial receiver, receives a time sequential signal representing an event (such as a television program). At least one recording means 40 records in a respective recording medium at least one respective selected portion of the time sequential signal. Retrieving means 18 retrieves at respective selectable intervals each respective selected portion of the time selected signal recorded in each recording medium, and generates a respective playback signal dependent thereon. Controlling means 24 controls each recording means to record each respective selected portion of the time sequential signal. The controlling means 24 also controls the retrieving means 18 to retrieve at each respective selectable interval each respective selected portion of the time sequential signal, so that the retrieving means 18 generates each respective playback signal. Thus, a representation of an event can be produced in a time shifted manner (as described above with reference to FIG. 2(a) and 2(b)).

In this embodiment of the present invention, as shown in FIG. 6, supplying means 42, controlled by the controlling means 24, supplies at least one of the respective playback signals and a current portion of the time sequential signal to a display device 44 simultaneously so that at least one time shifted representation of the event can be displayed simultaneously with a current representation of the event on the display device. In other words, a time shifted event representation TSER can be displayed at one portion of a television screen while a current event representation CFR is displayed at another portion of the television screen. In this way, the viewer can choose to recall and review again a selected portion of the television program while continuing to view the current event representation in real time.

In accordance with the present invention, supplying means 42 controlled by the controlling means 24 supplies at least two of the respective playback signals to a display device simultaneously so that at least two time shifted representations of the event can be displayed simultaneously on the display device In other words, in accordance with one embodiment of the present invention the time sequential signal of an event, such as a television program, is recorded as shown by way of example in FIGS. 2(a) and 2(b). At the user's option. two or more portions of the event can be replayed simultaneously and viewed by the viewer on a display device 44, such as a television set. As with other embodiments, each recording medium may be a magnetic tape, magnetic disk, electronic memory circuit (such as an integrated circuit device disposed on a silicone chip), an optically recordable disk or other suitable recording medium. It is particularly noted that various means for recording information are being constantly developed. Therefore, the present invention is intended to include the use of such information storage devices whether currently known or developed at such future time.

As with a previously described embodiment, in accordance with the embodiment shown in FIG. 6, each recording medium can be a portion of a recordable disk so that each recording means writes to and reads from the same recordable disk. Alternatively, each recording medium can comprise a portion of memory of a same electronic memory circuit. In this case, each recording means stores information on a same electronic memory circuit. Furthermore, as with the other embodiments, each recording means may record the time sequential signal as digital data, analog data or the like.

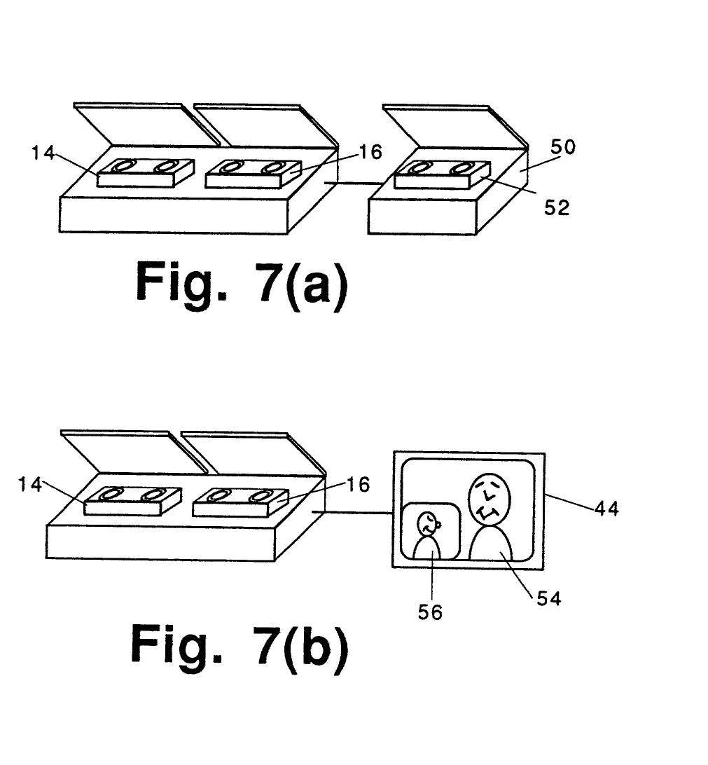

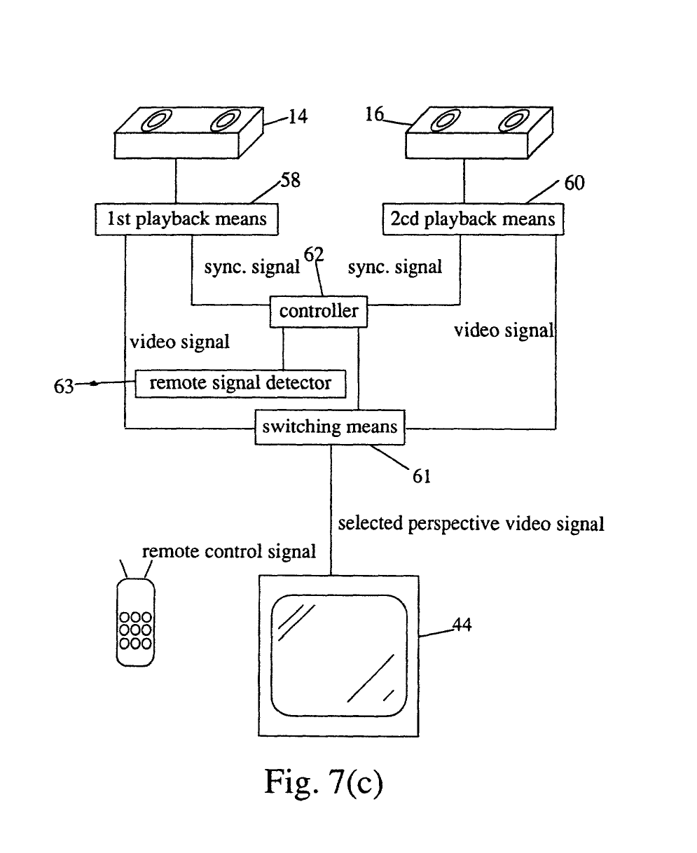

FIG. 7(a) is a perspective view of an embodiment of the present invention that utilizes a record/playback system 48 of the configuration of the inventive time shifting event recorder shown, for example, in FIG. 4(b) in conjunction with a VCR 50 (or other storage device) to playback and record onto a single videotape 52 the program temporarily stored non-continuously on the two recording mediums 14, 16 In this use, the inventive time shifting event recorder is used to playback a correctly sequenced continuous version of a recorded event for storage on a single recording means, such as a videotape 52 recorded by a VCR 50. Thus, the viewer can permanently store the recorded event for later viewing, allowing the dual recording capabilities of the inventive time shifting event recorder to be used again for controlled viewing of another program, without losing the program previously recording in a time shifting manner on the two recording mediums 14, 16.

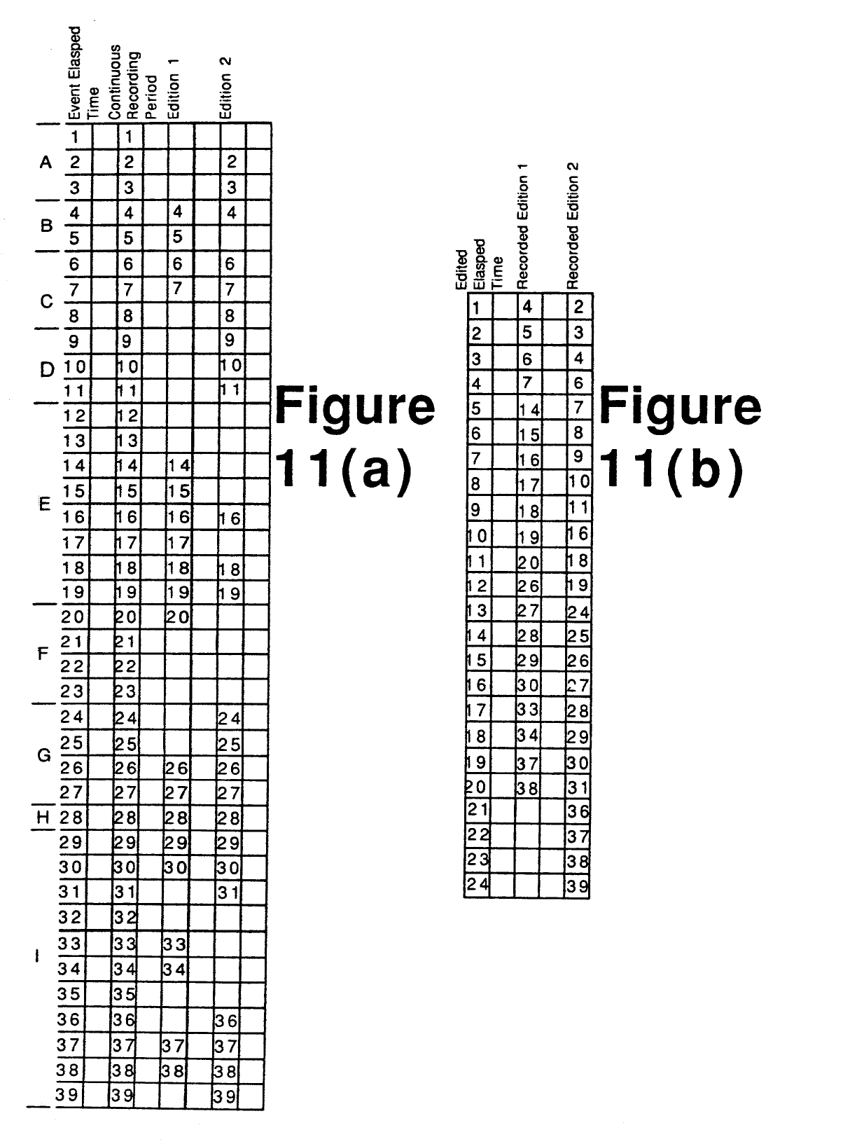

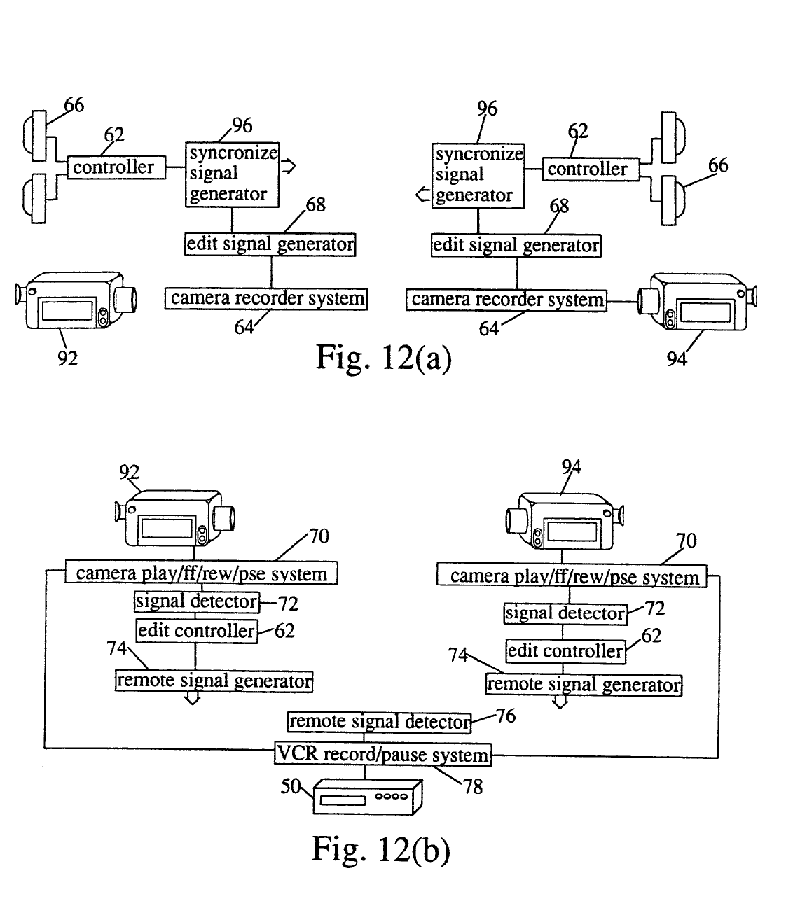

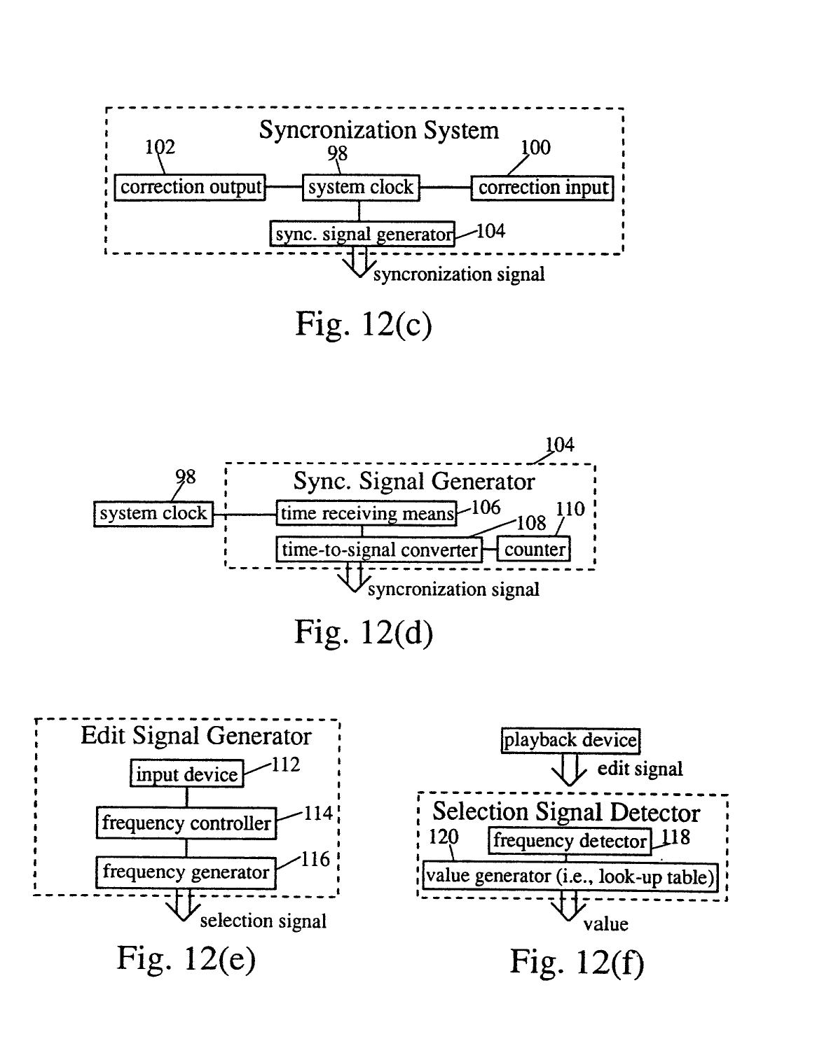

In accordance with another aspect of the present invention, the dual playback capability of the inventive time shifting event recorded is used for playing synchronized recordings for producing an automatically edited version of a recorded event. A recorded event is stored on at least two synchronized recorded tapes 14, 16. The synchronized recorded tapes 14, 16 store the recorded event captured from different respective perspectives (as described below with reference to FIGS. 12(a)-16(c)). FIG. 7(a) shows the inventive time shifting recorder and a conventional VCR 50 used to playback and record the two synchronized tapes to produce an automatically edited version containing both perspectives with synchronized timing. The video signal from both synchronized recorded tapes 14, 16 is controlled (as will be described below) so that the event is recorded onto an edit-recorded tape (videotape 52) with a correct sequence. For example, the recorded event may contain a scene of dialogue between two actors. As a first alternative, a first synchronized recorded tape 14 may have a perspective of one actor, while a second synchronized recorded tape 16 may have a perspective of another actor. During playback of the scene from the two synchronized recorded tapes 14, 16, the viewer can choose at any time between a variety of viewing options, such as switching between the two actors during the dialogue, or using a split screen (picture-in-picture) display of both actors, etc. For example, the first synchronized recorded tape 14 may have a perspective switching between a close-up of each actor as he speaks during the dialogue, while the second synchronized recorded tape 16 may have a perspective viewing both actors at one.

FIG. 7(b) is a perspective view of the embodiment of the present invention shown in FIG. 7(a), showing user definable perspectives of the synchronized recordings played on a monitor 44. In the example given above, a first perspective 54 is obtained from a first synchronized recorded tape 14 and shows the speaking actor in the scene of dialog. A second perspective 56 is obtained from the second synchronized recorded tape 16 and shows the listening actor. The viewer can choose between the two perspectives, or as shown, can view both perspective in a split screen display. Also, a videodisk can be used to store more than one perspective since the rapid access time of the videodisk will not interfere with the continuity of the displayed recorded event. A lag time will be caused by the access to a new selected perspective (which will require searching a correct synchronization signal from the disk for the selected perspective). However, by using two or more disks, this lag time will have little or no effect on viewing. A perspective from one disk can be displayed during the search for the synchronization signal for the selected perspective from the other disk. Also, two or more read/write heads can be used to retrieve the selected perspectives from a single disk.

FIG. 7(c) is a block diagram of components of the playback components for viewing synchronized recorded tapes 14, 16. In the case of continuously played synchronized recorded tapes 14, 16 (or randomly accessible disk storage), first playback means 58 and second playback means 60 are controlled by a controller 62 to generate a time synchronized video signal from the respective first and second synchronized recorded tapes 14, 16. The controller 62 receives a synchronization signal recorded or otherwise associated with each of the tapes to maintain the synchronicity of the different perspectives of the recorded event. A remote signal detector 63 receives signals from a viewer-controlled remote control, and these signals are sent to the controller. The controller 62 controls switching means 61 in response to the remote signal so a selected video signal is generated. The selected video signal may include the perspective obtained from either the first and second synchronized video tape 14, 16, or a combination of the perspectives in a split screen display. Also, either perspective can be fast forwarded or rewound for controlled viewing, and then re-synchronized with the other perspective at a later time by the controller 62 controlling the playback means 58, 60 to fast forward, rewind, play or stop as necessary to re-synchronize the first and the second recording mediums 14, 16.

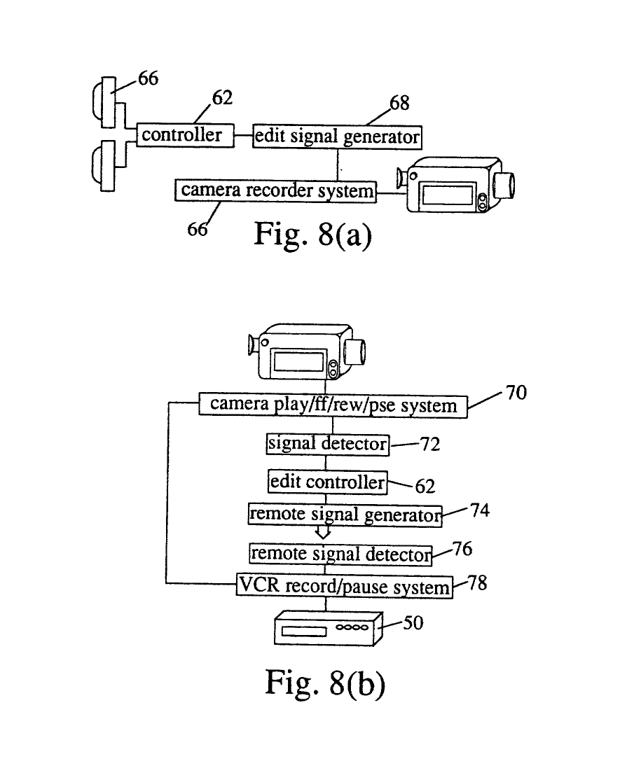

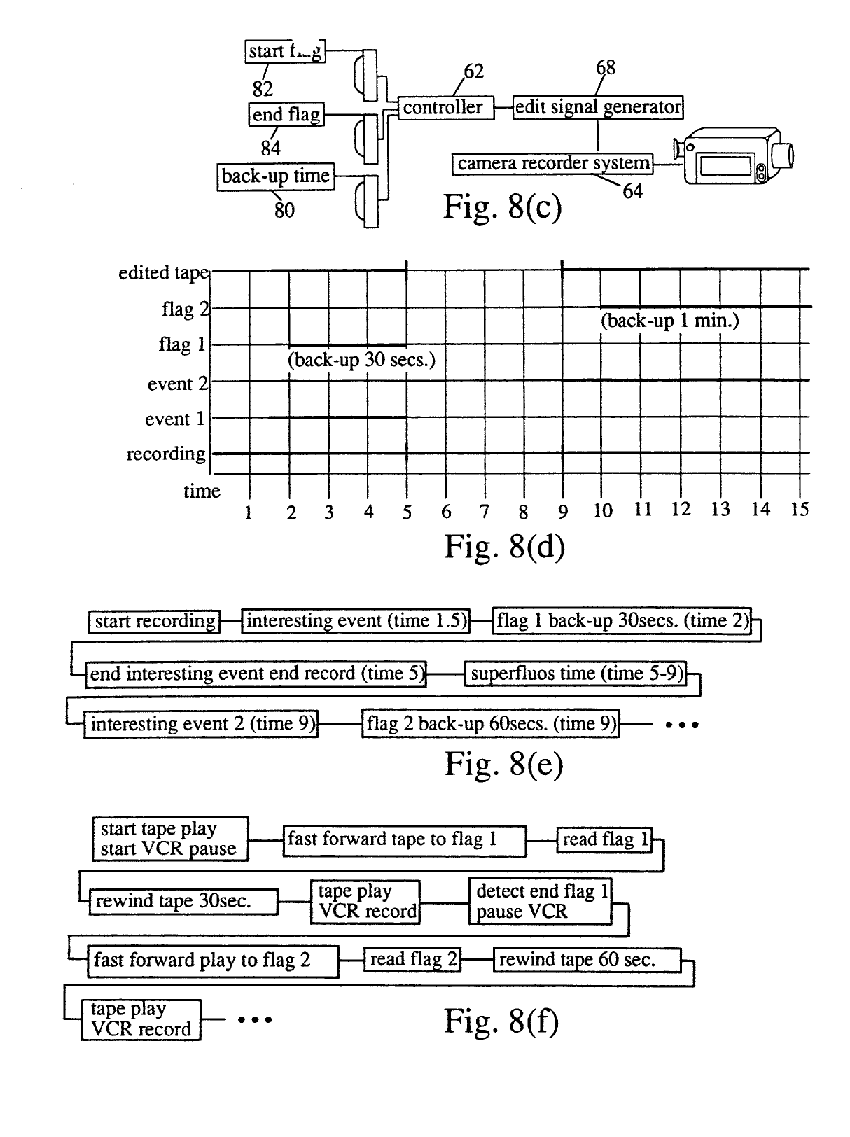

FIG. 8(a) is a block diagram of an inventive automatic edit event recording system. In accordance with this aspect of the invention, event-recording means (camera recording system 64) records an event on a recording medium, such as a VHS, beta, or 8 mm video tape (or any other recording medium described herein). Selecting means (manual control buttons 66) is provided for selecting at least one edit-record interval corresponding to a respective selected portion of the recorded event. Signal generating means (edit signal generator 68) generates a start-record signal dependent on each selected edit-record interval. Signal recording means records each start-record signal on the recording medium. In accordance with the invention, the audio and/or video recording system of the camera (camera recording system 64) can be used to record the start-signal onto a videotape or other recording medium. As an example, the edit signal generator 68 may generate an audio signal that contains separate start-record information for each edit-record interval. The audio signal should be above or below the range of human hearing so as not to interfere with the eventual viewing of the recorded event. The audio signal generated by the edit signal generator 68 can be sent to the camera recording system 64 to be stored on the videotape as the event is being recorded simultaneously on the same videotape by the camera recording system 64.

FIG. 8(b) is a block diagram of an inventive automatic edit playback and edited-recording system used to perform a subsequent edit-recording operation. The event recording means (i.e., camera play/fast-forward/rewind/pause system 70) performs a playback operation to playback a video/audio signal of the recorded event containing the start-record signal that is reproduced along with the playback of the recorded event. Signal detecting means detects during the subsequent edit-recording operation each start-record signal from the recording medium (videotape 52). An edit controller 62 (which may be a part of or include the controller 62) controls the event-recording means (camera play/fast-forward/rewind/pause system 70) and an edited-recording means (VCR 50) during the edit-recording operation so that a play-back operation to play-back the event from the recording medium (videotape 52) is performed by the event-recording means (camera play/fast-forward/rewind/pause system 70), and a record operation to record an edited version of the event is performed by the edited-recording means (VCR 50). The edit controller 62 effectively controls the record operation during the subsequent edit-recording operation dependent on each of the detected start-record signals to record a copy of the recorded event having each said selected edit-record interval. To speed-up the time required to. make the edited version, the controlling means may also includes means for controlling the event recording means (camera play/fast-forward/rewind/pause system 70) to fast forward the recording medium (videotape 52) through periods of the recorded event that are not the selected edit-record intervals (i.e., the uninteresting superfluous portions of the recorded event). The edit controller 62 controls the VCR 50 through a remote signal generator 74 that generates signals receptive by a remote signal detector 76 of the VCR SO. Since different VCRs respond to different remote signals, the remote signal generator 74 should be capable of producing different remote control signals (similar to a universal remote control).

Stated otherwise, during the recording of an event, a user of a video camera operates manual control buttons 66 to flag selected portions of the recorded event that are of interest and that should be included in a final edited version. Thus, the recorded videotape 52 contains the flagged interesting portions as well as the superfluous portions of the recorded event. During a subsequent edit-recording operation, the recorded video is played back by a playback device. The record/pause system 78 of a VCR 50 and the play/fast-forward/rewind/pause system of the playback device are controlled, so that only the flagged interesting portions of the recorded event are re-recorded onto the edited version, with the superfluous portions being automatically edited out.

FIG. 8(c) is a block diagram of an inventive automatic edit event recording system having a manual control button for selecting a beginning time of an edit-record interval. In accordance with this construction of the invention, the selecting means (manual control buttons 66) includes means for selecting a beginning time (“back-up time” button 80) of the edit-record interval. The beginning time occurs at a time prior to a time that the edit-record interval is selected (i.e., prior to depressing the “start flag” button 82. The signal generating means includes means for generating beginning time data along with the start-record signal. During a subsequent edit-recording operation, the camera play/fast-forward/rewind/pause system 70 (or other playback device) is controlled for rewinding the recorded videotape to the beginning time of the edit-record interval dependent on the start-record signal with the included beginning time data. In accordance with this feature of the invention, a user can include in a final edited version of an event, a portion of the recorded event that occurred prior to pressing the “start flag” button 82.

For example, if a user is recording a fishing expedition using a camcorder, there is no way to predict exactly when a fish will strike. To avoid including on the edited version of the event the boring superfluous wait for the fish strike, the user will not depress the “start flag” button 82 until after the fish has struck. In this case, the fish strike is not flagged for recording onto the edited version. However, by depressing the “back-up time” button 80, the start-record signal recorded on the recording medium at the time of depressing the “start flag” button 82 includes the beginning time. The amount of back-up time can be controlled to include an appropriate portion of the recorded event occurring before depressing the “start flag” button 82 so that the entire desired portion (i.e., the strike of the fish and the fight of the fish) can be automatically included in the final edited version of the recorded event. For example, depressing the “back-up time” button 80 once may include a 30 second beginning time data with the start-record signal so that the tape containing the entire recorded event is rewound 30 seconds. Each subsequent depressing of the “back-up time” button 80 may add an addition time, such as increments of 30 seconds to the amount of time that the tape is rewound. To simplify the operation, a single button can be used for both the “start flag” and the “back-up time”, in which case, the back-up time is included starting with the second depressing of a “start flag/back-up time” button. An “end flag” button 84 is depressed after the desired portion of the recorded event has been recorded.

FIG. 8(d) is a graphic illustration showing an example of a time relationship of an inventive automatic editing operation with manual beginning time selection. FIG. 8(e) is a flow diagram of an automatic edit event recording operation and FIG. 8(f) is a flow diagram of an automatic edit playback and edited-recording operation in accordance with the time relationships shown in FIG. 8(d). Referring to FIGS. 8(d) and 8(e), an entire event is recorded starting with a start recording operation. An interesting event may occur at minute 1.5. However, the user does not depress the “start flag” button 82 to record flag 1 (start-record signal) until minute 2. To include the beginning of the interesting event, the user depresses the “back-up time” button 80 once, and a 30 second beginning time data is included in the start-record signal of flag 1. The interesting event ends at the start of minute 5, so the user depresses the “end flag” button 84 to record the end on the selected portion of the recorded event. From minutes 5-8 the event is boring and contains superfluous uninteresting occurrences. Than, another interesting event happens at the start of minute 9, but the user does not appreciate the interest until minute 10. To include the beginning of this interesting event, the user depresses the “back-up time” button 80 twice, and a 60 second beginning time data is include in the start-record signal of flag 2.

FIGS. 8(d) and 8(f) show the operation to obtain an edited tape containing the interesting portions of the recorded event with the boring superfluous portions edited out. The camera (or other play-back device) plays the tape containing the recorded event, and a VCR 50 (or other recording device) is set to pause. The tape is fast forwarded (or played) until flag 1 is detected and read. The start-record signal of flag 1 includes the 30 second beginning time data, so the tape is rewound 30 seconds to the beginning of the first interesting event. The tape is than played and a video signal is generated by the playback device, while the VCR 50 records the first interesting event onto the edited tape. After the end of flag 1 is detected, the VCR 50 is set to pause. The tape is then fast-forwarded to flag 2, which is detected and read. The start-record signal of flag 2 includes the 60 second beginning time data, so the tape is rewound 60 seconds to the beginning of the second interesting event. The tape is than played and a video signal is generated by the playback device, while the VCR 50 records the second interesting event onto the edited tape. Using this procedure, an edited tape is obtained containing only the interesting portion of the recorded event, while the superfluous boring portions of the recorded event are automatically edited out.

FIG. 9(a) is an illustration showing the timing of an example of the operation of the automatic edit event recording operation, while FIG. 9(b) is an illustration showing the timing of an example of the automatic edit playback and edited-recording operation. For example, during a continuous recording period (ABC), the user selects minutes 4-7 as being interesting (FIG. 9(a)). As described above, a start-recording signal is recorded along with the interesting portion of the event so that a playback device and a recording device are controlled in such a manner that a final edited version of the recorded event does not include minutes 1-3 or 8 of recording period (ABC). By following this procedure, the edited elapsed time is only 20 minutes and contains only the interesting portions of the recorded event (FIG. 9(b)). By contrast, the unedited tape includes 34 minutes of the recorded event (continuous recording periods), while the event has an event elapsed time of 39 minutes. Thus, it can be appreciated that the final edited version contains only the interesting portions, making viewing of the recorded event enjoyable.

10(a) is a block diagram of an inventive automatic edit event recording system having manual control buttons 66 for selecting automatically edited editions of a recorded event. The automatic edit event recording system has first, second and third edition buttons 86, 88, 90 for obtaining different edited editions of a recorded event, with each edition containing different portions of the recorded event considered to be appropriate for the edition. Thus, in accordance with this configuration of the invention, the selecting means includes means (first, second and third edition buttons 86, 88, 90) for selecting an edit-edition for each edit record interval. The signal generating means includes means for generating the start-record signal including an edit-edition data (i.e., edition 1, 2 or 3), and the controlling means includes means for controlling the event-recording means (camera) and. the edit-recording means (VCR) so that the edit-recording means records an edition copy of the recorded event having each said selected edit-record interval being the same edit-version. By this process, different editions can be obtained from an automatically edited recorded event.

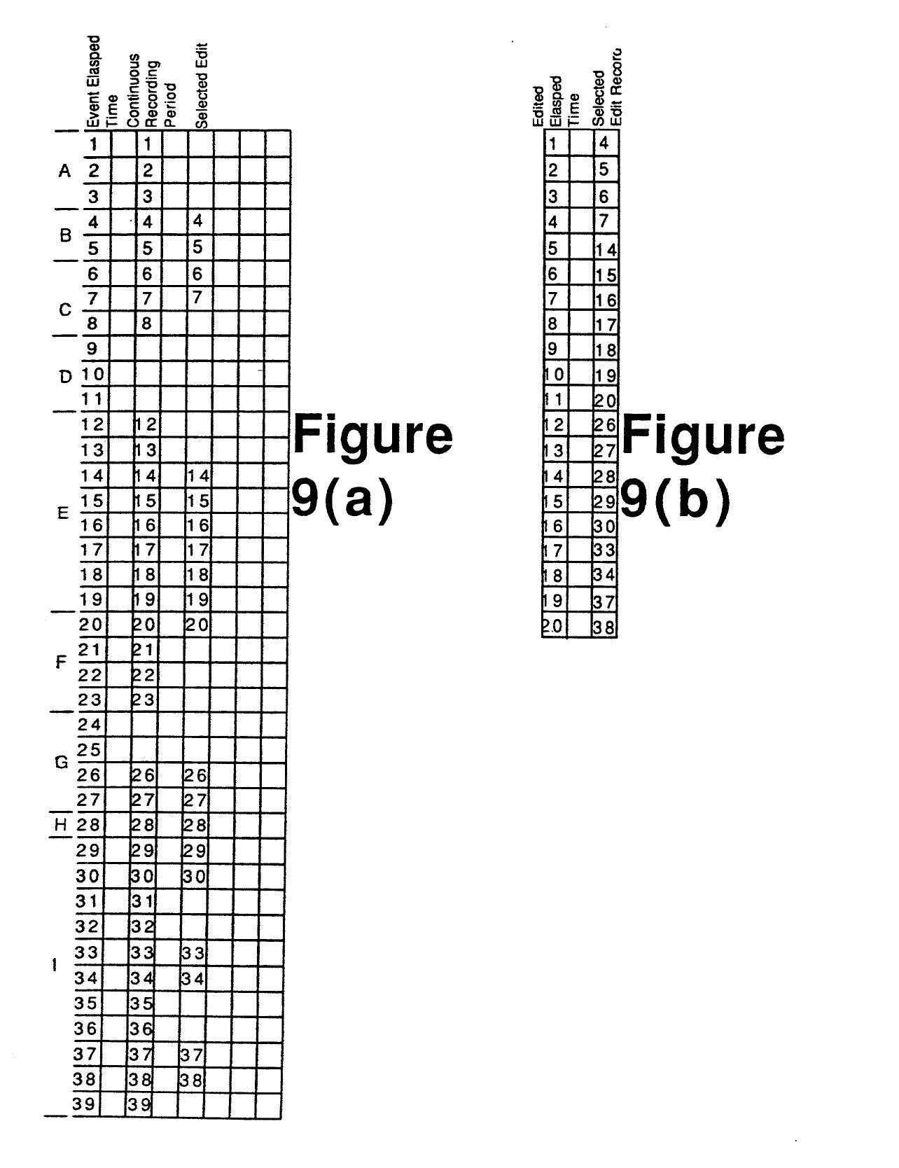

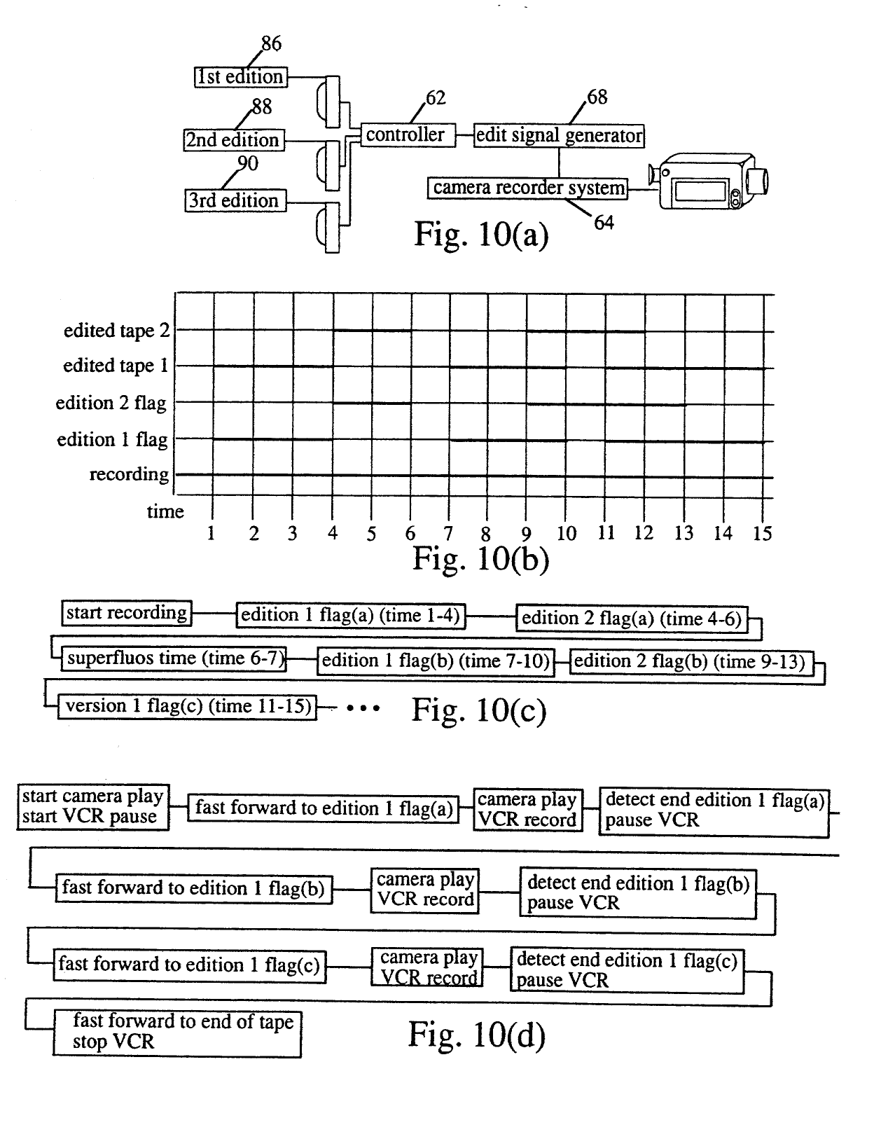

FIG. 10(b) is a graphic illustration showing an example of a time relationship of an inventive automatic editing system with manual edition selection. FIG. 10(c) is a flow diagram of an automatic edit event recording operation, and FIG. 10(d) is a flow diagram of an automatic edit playback and edited-recording operation in accordance with manual edition selection.

As shown in FIGS. 10(b) and 10(c), an event is recorded starting with a start recording operation. At minute 1, the user decides to include a subsequent portion of the recorded event a first edition and depresses edition 1 button 86. Edition I flag(a) (containing edit-edition 1 data) is generated and recorded on the tape along with the event indicating that edition 1 includes minutes 1-4 of the recorded event (depending on the circuit construction, the edition 1 button 86 may be depressed indicating the end point at minute 4, or a separate edition end button (not shown) may be provided). At minute 4, edition 2 button 88 is depressed, edition 2 flag(a) (containing edit-edition 2 data) is generated, and thus edition 2 contains minutes 4-6. Superfluous time occurs during minutes 6-7, so it is not included in either edition 1 or edition 2. At minutes 7-10, edition 1 flag(b) is set, while at time 9, edition 2 flag(b) is set (note, edition 1 and edition 2 both contain minute 9)˜. Than. at minutes 11-15, edition 1 flag(c) is set to include minutes 11-15 in edition 1. As shown in FIGS. 10(b) and 10(d), during an edit-recording operation, the playback device (camera or VCR 50) and the edit-recording device (VCR 50) are controlled so that two edition copies (edited tape 1 and edited tape 2) of the recorded event are produced having only the respective selected edition events in accordance with the edit-edition data recorded with the start-record data.

FIG. 11(a) is an illustration showing timing of an example of the operation of the automatic edit event recording operation with edition selection, and FIG. 11(b) is an illustration showing the timing of an example of the automatic edit playback and edited-recording operation with edition selection. The edition timing capabilities of the invention are useful when different edited editions of a recorded event are desired. For example, a recorded event may include portions of distinct interest to two or more groups of future viewers, such as a prime-time version of a new event without explicit footage, and a light-night or cable TV version of the new event with explicit footage. This feature can also be used when recording group activities in which each edited edition contains a focus on a different primary subject (i.e., a coach can record entire game of an opponent and provide each of his key players with an edited version specific to the player's position). As shown in FIGS. 11(a) and 11(b), a first recorded edition is automatically edited to contain only 20 minutes of edited elapsed time containing specific portions of a 39 minute event, while a second recorded edition is automatically edited to contain only 24 minutes of edited elapsed time containing specific portions of the 39 minute event.

FIG. 12(a) is a block diagram of an inventive automatic edit event recording system having synchronizing system for synchronizing two or more recorded perspectives of a recorded event, and FIG. 12(b) is a block diagram of an inventive automatic edit playback and editing recording system having a synchronizing system for synchronizing two or more recorded perspectives. In accordance with this embodiment of the invention, an auto-editing device for at least two recording apparatus capable of simultaneously recording an event on a respective recording medium is provided. Selecting means (manual control buttons 66) selects edit-record intervals and a perspective of the event being recorded taken by first recording apparatus (video camera 92 of the user) or corresponding to a second perspective of the event being recorded taken by a second recording apparatus (video camera 94 of a companion). Signal generating means (edit signal generator 68) generates a corresponding start-record signal including the perspective selection signal dependent on the selected edit-record interval. Signal recording means (camera recording system 64) records each star˜signal on a recording medium (videotape of the camera 92 of the user). Each camera system 92, 94 includes a synchronization signal generator 96 that generates a synchronization signal (each based on a respective system clock that is synchronized with the system clock of the other camera system). The synchronization signal is used to keep the playback of the respective recorded videotape 52 obtained from each camera system in synchronism with the playback of the recorded videotape 52 of the other camera system(s). Detecting means (signal detector) detects during a subsequent edit-recording operation (FIG. 12(b)) the start-record signal from the recording medium (i.e., the tape from the camera 92 of the user). An edit-record controlling means (edit controller) receives the detected start-record signal as well as a synchronization signal recorded continuously or at specific intervals on each video tape. The edit controller 62 controls a recording device (VCR 50) during the subsequent edit-recording operation dependent on each detected start-record signal (including the perspective selection signal) to record a single copy of the recorded event having the first perspective of the event being recorded taken by the first recording apparatus (camera 92) and the second perspective of the event being recorded taken by the second recording apparatus (camera 94) kept in synchronism by the synchronize signal recorded on the respective video tapes. Thus, the edited tape has a correct time sequence and has the recorded scene switching between the two (or more) perspectives.

FIG. 12(c) is an isolated block diagram of a synchronizing system that includes the synchronization generator 96. The synchronization system includes a system clock 98 that generates a time signal. The system clock 98 should be precise, so that perspectives taken by different cameras can be matched up in an edited version having a consistent time sequence (particularly important for, for example, a conversation recorded from two perspectives). Such a precise clock may be obtained, for example, based on the oscillation of an excited quartz element. The system clock 98 can be corrected by a correction synchronization signal received by the correction input 100 from the correction output 102 of the synchronization means of another camera. Thus, prior to recording an event, each camera should be linked together (directly, using a conducting cable, or indirectly using an infrared or radio signal) so that the system clock 98 of each camera is in synchronism. A clock signal from the system clock 98 is used by a synchronization signal generator 96 to generate an appropriate synchronization signal at an appropriate time (i.e., continuously, or at predetermined intervals). This synchronization signal is recorded on the videotape 52 along with the event being recorded.

FIG. 12(d) is an isolated block diagram of a synchronization signal generator 96 of the synchronization system. A clock signal from the system clock 98 is received by time receiving means 106, the clock signal is converted to the synchronization signal by a time-to-signal converter 108. The time-to-signal converter 108 may be controlled by a counter 110 so that a count signal corresponding to a predetermined interval is generated as the synchronization signal at predetermined intervals. The time-to-signal converter 108 may be, for example, an A/D converter for converting an analog clock signal into a digital value (or vice-versa using a D/A converter).

FIG. 12(e) is an isolated block diagram of an edit signal generator 68. An input device 112 (such as the manual control buttons 66 used as the selecting means) activates a frequency controller 114 that controls a frequency generator 116 to generate an edit signal having the appropriate control data (i.e., start-record data, edit version data, beginning time data, etc.). The frequency generated depends on the input device (i.e., manual control buttons for start flag, end flag, edition flag, beginning time, etc.). The frequency may be recorded on the audio-recording portion of the videotape 52 and have a value that is above or below the range of human hearing so as not to interfere with the eventual viewing the edited tape. Also, the different signals representing different control data may be recorded simultaneously at different frequencies.

FIG. 12(f) is an isolated block diagram of an edit signal detector. An edit signal (start-record signal) that was recorded on a videotape 52 is regenerated by a playback device. This edit signal is received by an edit signal detector 72. The edit signal detector 72 includes a frequency detector 118 (such as a filter) that detects the edit signal from the other frequencies generated when the recorded videotape is played by the playback device. The detected frequency is used to generate a value from a value generator 120 (i.e., a look-up table, or other addressable value storage device or value generator). This value is received by the edit controller 62 to enable the appropriate control of the playback device and edit-recording means so that an edited version of the recorded event is obtained in accordance with the present invention.

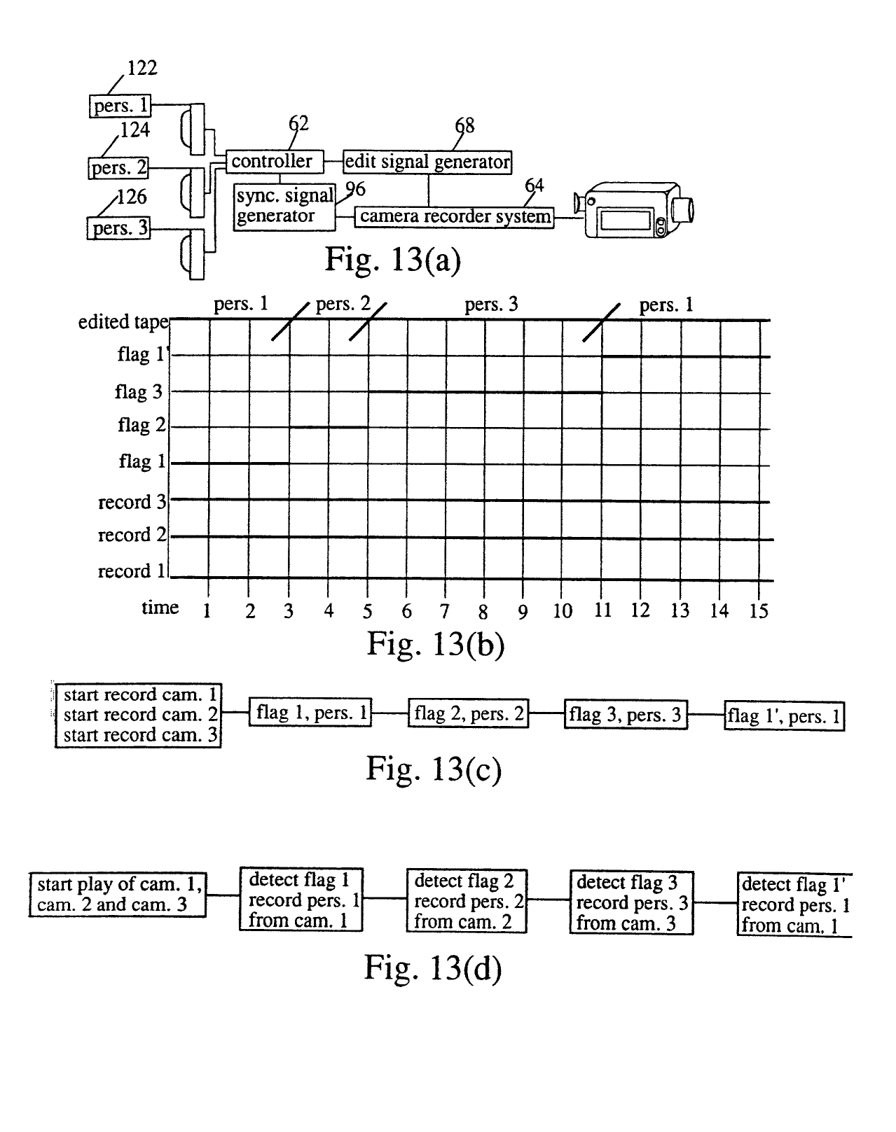

FIG. 13(a) is a block diagram of an inventive automatic edit event recording system having manual control buttons 66 for selecting perspectives of a recorded event. Selecting means (pers. 1, pers. 2, pers. 3, 122, 124, 126) selects an edit-record interval corresponding to a perspective of the event being recorded taken by a first recording apparatus (video camera of the user) and a second edit-record interval corresponding to a second perspective of the event being recorded taken by a second recording apparatus (video camera of a companion). Although three manual control buttons labeled pers. 1, pers. 2, and pers. 3, 122, 124, 126 are shown, the number of perspectives is not necessarily limited to that three. Two or more perspectives may be accommodated, and a simple toggle switch may be used to switch between two perspectives (user and companion).

FIG. 13(b) is a graphic illustration showing an example of a time relationship of an inventive automatic editing system with perspective selection. FIG. 13(c) is a flow diagram of an automatic edit event recording operation, and FIG. 13(d) is a flow diagram of an automatic edit playback and edited-recording operation of the automatic editing system with perspective selection. Each camera (in this example, three cameras are used) records the event from a different perspective. The user can control the generation of a perspective flag generated as a start-record signal depending on a selected perspective. As shown in FIGS. 13(b) and 13(c), at minutes 0-3, the user selects perspective I, and a start-record signal flag 1 is recorded on the videotape 52 of the user's camera. At minutes 3-5, the user selects perspective 2 which is recorded on the videotape 52 contained in camera 2, and a start-record signal flag 2 is recorded on the videotape 52 of the user's camera. A similar procedure is used to record a start-record signal corresponding to flag 3 (perspective 3 from camera 3) and flag 1′ (perspective 1 again, from camera 1). During the automatic editing operation, a playback device (i.e., camera 1, camera 2 and camera 3) is used to playback the recorded event from each of the respective videotape 52s. A video signal from each camera is controllably switched to an edit-recording device (i.e., VCR 50) at appropriate times depending on the detected start-record signal from the camera 1 videotape 52. Thus, an edited tape containing minutes 0-(beginning of)3 with perspective 1, minutes 3-(beginning of)5 with perspective 2, minutes 5-(beginning of)11 with perspective 3 and minutes 11-15 with perspective 1, again, is automatically produced. A synchronizing signal may be used to maintain the synchronicity between the playedback videotape, although, if each camera starts recording of the event simultaneously, the synchronizing signal may be obviated so long as the playback of the tape from each camera is simultaneously controlled.

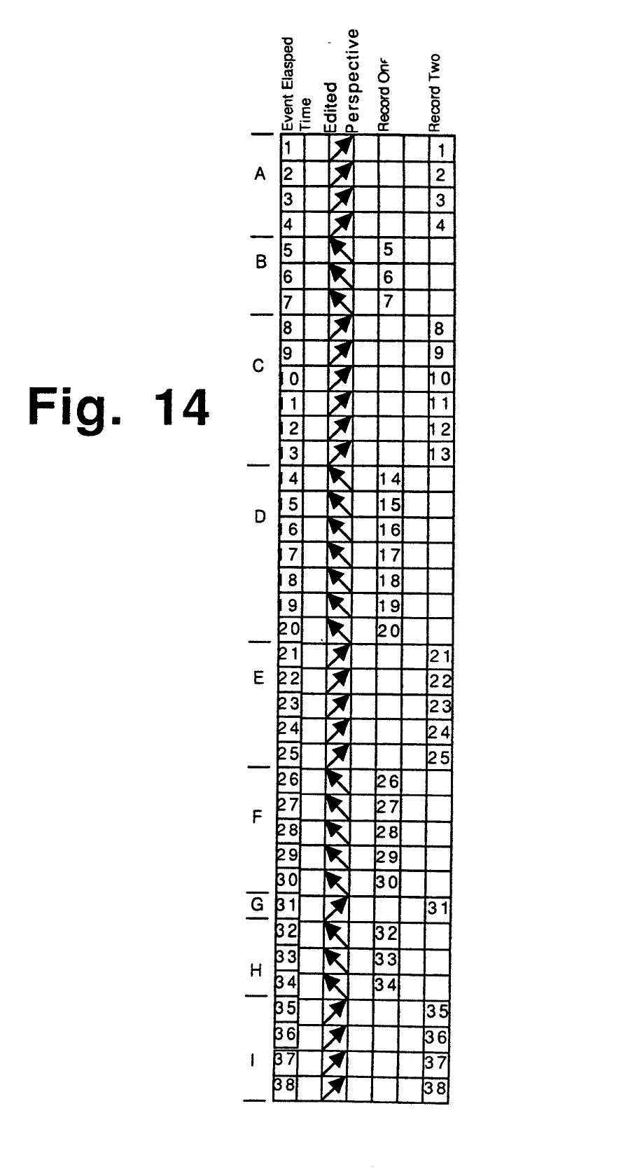

FIG. 14 is an illustration showing the timing of an example of the operation of the automatic edit event recording operation with perspective selection. As shown, a different perspective may be recorded by two different video camera (record one and record two). The user of one of the cameras determines an edited perspective of an edited version by selecting at arbitrary times during the event the perspective to be on the final edited version. The user of each camera may control his own edited version. The arrows show the edited perspective at the various minutes of the event, wherein a rightward pointing arrow indicates the perspective of video camera record two, and the leftward pointing arrow indicates the perspective of video camera record one.

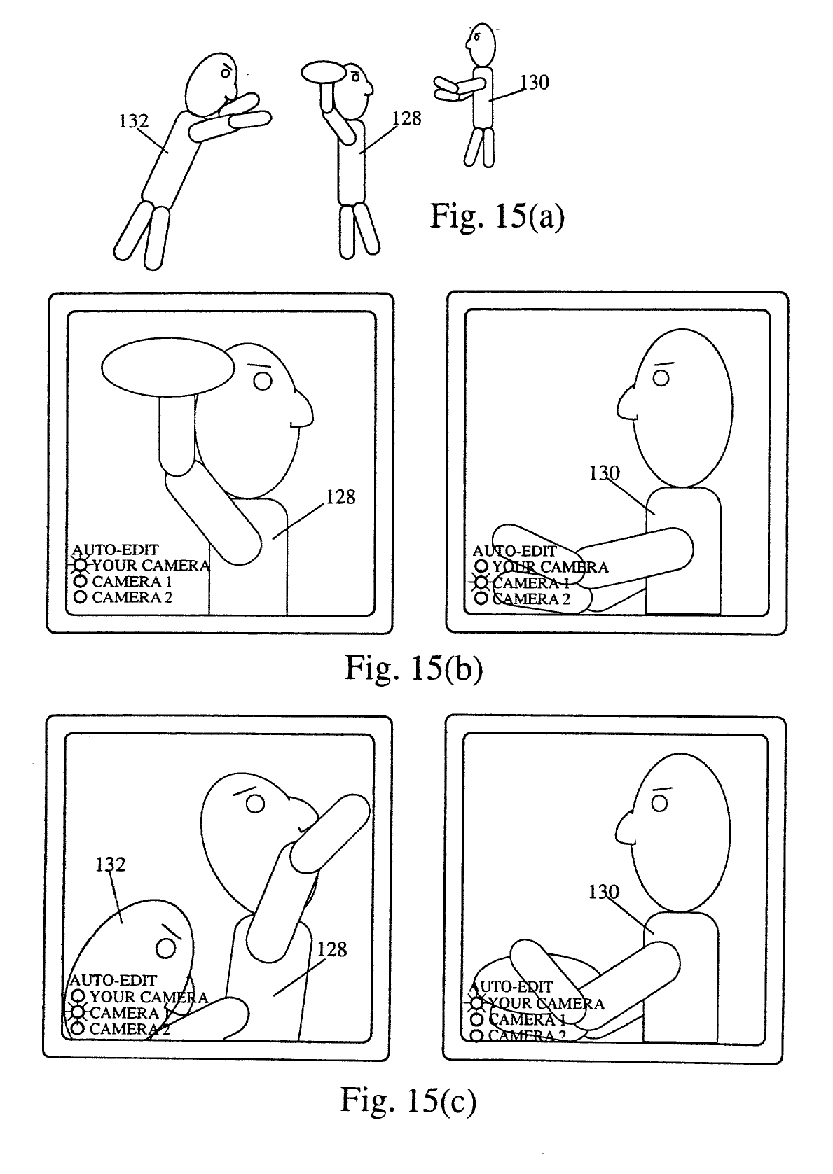

FIG. 15(a) is an illustration of an event being recorded. In this case, the event is a play in a football game in which a quarterback 128 is passing a football to a receiver 130. A defender 132 is after the quarterback 128 and attempting to sack him.

FIG. 15(b) shows two recorded perspectives of the event being recorded shown in FIG. 15(a) as viewed in a viewfinder of a user camera (your camera) and a companion camera (camera 1). The viewfinder on the right shows the perspective of the play (the event) taken by the user camera, which is an upclose focus on the quarterback 128. The viewfinder on the left shows the perspective of the play taken by the companion camera, which is an upclose focus on the receiver 130. The viewfinder of the user camera has an information screen that indicates the perspective chosen. In this case, the user has chosen his camera (your camera) as the perspective to be recorded onto the edited tape for future viewing. The companion has also chosen the user camera perspective (camera 1 in the information screen of the companion camera).

FIG. 15(c) shows two recorded perspective of the event being recorded in FIG. 15(a), after the play has proceeded with the receiver 130 catching the football thrown by the quarterback 128, and the quarterback 128 being tackled by the defender 132. The user has chosen the companion camera (camera 1), since this is where the action is. However, the user may also wish to include the shot of the tackle. Even though the catch by the receiver 130 occurs simultaneously with the tackle of the quarterback 128, and the user has already chosen the perspective of the companion camera (the catch), it is still possible to include the tackle on the edited version. This is done by selecting a proper start-recording signal for later control of the playback means and the edit-recording means. In this case, to obtain the tackle on the final edited version, the user can select perspective 1 (your camera) and back-up time 30 secs. (as described above with reference to FIG. 8(c)). This is just one example of the enhance control of the final edited version afforded in accordance with the present invention in which a combination of the auto-editing features described herein can be selected to obtain encompassing control of an edited version of a recorded event

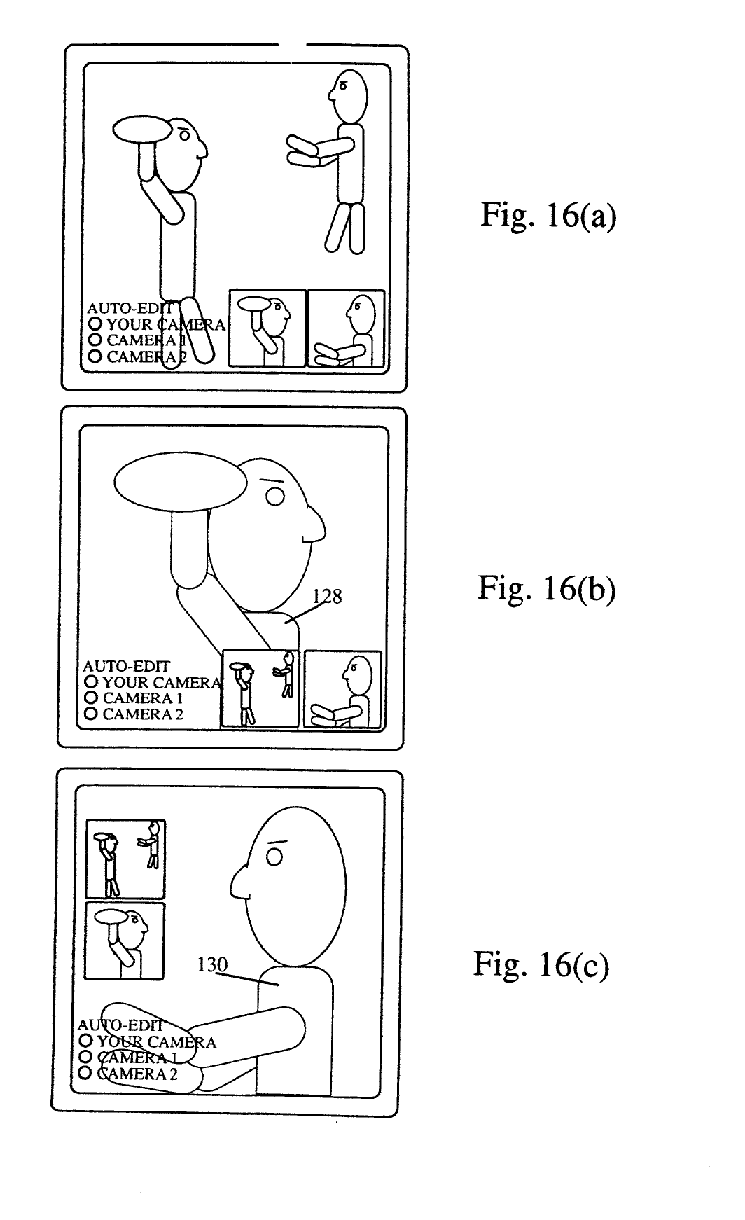

FIGS. 16(a) through 16(b) show the viewfinders of three different camera perspectives. Each viewfinder includes a picture-in-picture display of the perspectives of the other cameras, and an information screen to indicate the selected perspective. The information screen may include other pertinent information, for example selected back-up time, start/end edit record, selected edition, etc. The picture-in-picture display is obtained by a video link (either direct through a cable, or indirect through radio or other signals) between the cameras.

With respect to the above description, it is realized that the optimum dimensional relationships for parts of the invention, including variations in size, materials, shape, form, function, and manner of operation, assembly and use, are deemed readily apparent and obvious to one skilled in the art. All equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents may be resorted to, falling within the scope of the invention.

What is claimed is:

1. In a processing system associated with a television, a method for pausing the display a television program that is included in a signal received at the processing system, comprising the acts of:
continually receiving the signal at the processing system, the signal including a sequence of images that represent the television program;
as the signal is continually received, recording the signal to a recording medium associated with the processing system;
as the signal is being recorded, displaying the television program included in the signal on the television;
in response to viewer input, pausing the display of the television program and continuing to record the signal;
in response to subsequent viewer input resuming display of the television program by displaying the signal that was recorded after the display of the television program was paused; and
continuing to record the signal.
